(19) United States
(12) Patent Application Publication
(10) Pub. No.: US 2003/0119402 A1
(43) Pub. Date: Jun. 26, 2003

(54) Absorbent article with stabilized absorbent structure

(75) Inventors: Shannon K. Melius, Appleton, WI (US); William G. Reeves, Appleton, WI (US); Peter R. Elliker, Appleton, WI (US); Michael J. Garvey, Appleton, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/324,683

(22) Filed: Dec. 18, 2002

Related U.S. Application Data
(63) Continuation-in-part of application No. 10/034,021, filed on Dec. 20, 2001.
(63) Continuation-in-part of application No. 10/037,385, filed on Dec. 20, 2001.
(63) Continuation-in-part of application No. 10/033,860, filed on Dec. 20, 2001.

(51) Int. Cl. B32B 5/02; B32B 27/04; B32B 27/12; D04H 1/00; D04H 3/00; D04H 5/00; D04H 13/00; D02G 3/00; D04H 3/16

(52) U.S. Cl. 442/327; 442/110; 442/401; 428/365

(57) ABSTRACT

Absorbent articles having stabilized absorbent structures are discussed. The absorbent structures include binder fibers and absorbent composites. The absorbent composites include a particle of superabsorbent material and an energy receptive additive. The absorbent structures having the absorbent composites are particularly suitable for exposure to dielectric heating, in general, and microwave heating, in particular.

### CROSS-REFERENCE TO RELATED APPLICATIONS

This a continuation-in-part of U.S. patent application Ser. No. 10/034,021 entitled “Absorbent Structures Having Low Melting Fibers”; 10/037,385 entitled “Method and Apparatus for Making On-Line Stabilized Absorbent Materials”; and 10/033,860 entitled “Targeted On-Line Stabilized Absorbent Structures”; all of which were filed on Dec. 20, 2001, and are fully incorporated herein by reference.

### BACKGROUND

In the general practice of forming fibrous web materials, such as airformed webs of absorbent material, it has been common to utilize a fibrous sheet of cellulosic or other suitable absorbent material which has been fiberized in a conventional fiberizer, or other shredding or comminuting device, to form discrete fibers. In addition, particles of superabsorbent material have been mixed with the fibers. The fibers and superabsorbent particles have then been entrained in an air stream and directed to a porous, foraminous forming surface upon which the fibers and superabsorbent particles have been deposited to form an absorbent fibrous web.

To form a stabilized airlaid web, binder materials have been added to the web structure. Such binder materials have included adhesives, powders, netting and binder fibers. The binder fibers have included one or more of the following types of fibers: homofilaments, heat-fusible fibers, bicomponent fibers, meltblown polyethylene fibers, meltblown polypropylene fibers, and the like.

Conventional systems for producing stabilized airlaid fibrous webs have mixed the binder fibers with absorbent fibers, and then deposited the mixed fibers onto a porous forming surface by using a vacuum system to draw the fibers onto the forming surface. Typically such conventional systems have required the use of excessive amounts of energy. Where the binder fibers are heat-activated to provide the stabilized web structure, it has often been necessary to subject the fibrous web to an excessively long heating time to adequately heat the binder fibers. For instance, a typical heating time for a through-air bonding system would be about 8 seconds. Additionally, it has been necessary to subject the fibrous web to an excessively long cooling time, such as during roll storage in warehouses, to establish and preserve the desired stabilized structure prior to further processing operations. As a result, such conventional systems have been inadequate for manufacturing stabilized airlaid webs directly in-line on high-speed machines.

Recently, however, techniques have been developed for manufacturing stabilized airlaid webs directly in-line on high-speed machines. These techniques can include: an airforming of a fibrous layer; and an exposing of the fibrous layer to dielectric energy during a distinctively short (e.g., less than about 3 seconds) activation period to activate the binder-fibers to provide the stabilized airlaid layer.

While such high-speed techniques of in-line manufacture have many advantages, exposing a fibrous layer containing particles of conventional superabsorbent material to dielectric heating does have its disadvantages. One disadvantage is the susceptibility of conventional superabsorbent material to explode or pop (similar to popcorn) when exposed to dielectric heating. Another disadvantage is the susceptibility of conventional superabsorbent material to arcing when exposed to dielectric heating. As a result of the superabsorbent material arcing, the fibrous layer may ignite or no longer be suitable for incorporation into personal care products such as diapers, children's training pants, adult incontinence garments, medical garments, sanitary napkins, and the like. Moreover, arcing in many methods of manufacture is viewed as undesirable for a variety of safety concerns.

### SUMMARY

The present inventors have recognized the difficulties and problems inherent in high-speed techniques of in-line manufacture of absorbent articles. In response thereto, the present inventors conducted intensive research toward the development of superabsorbent-containing absorbent structures capable of being subjected to dielectric heating, in general, and microwave heating, in particular. The absorbent composites suitable for incorporation into the absorbent structures of the present invention are believed to minimize or eliminate the exploding or popping that often occurs when a particle of conventional superabsorbent material is exposed to dielectric heating. Moreover, the absorbent composites are believed to minimize or eliminate the amount of arcing that often occurs when a particle of conventional superabsorbent material is exposed to dielectric heating. By reducing or eliminating arcing, the absorbent structures of the present invention may be subjected to dielectric heating. Any reduction or elimination of arcing would have a positive impact on the amount of waste that often occurs in the manufacture of absorbent structures that are exposed to dielectric heating. Moreover, any reduction or elimination of arcing would increase the level of safety associated with manufacturing absorbent structures that are subjected to dielectric heating.

In one embodiment, an absorbent article is described. The absorbent article has a liner (adapted for contiguous relationship with a wearer's body), an outer cover (in generally opposed relationship with the liner) and an absorbent body. The absorbent body is disposed between the liner and the outer cover. Moreover, the absorbent body includes a non-woven absorbent structure having a unitary construction. The absorbent structure has binder fibers, which have been activated to form inter-fiber bonds within the absorbent structure. The absorbent structure also includes an absorbent composite. The absorbent composite includes a superabsorbent material and an energy receptive additive. The energy receptive additive has a dielectric loss tangent of at least about 0.15.

In another embodiment, an absorbent article is disclosed. The absorbent article has a liner (adapted for contiguous relationship with a wearer's body) an outer cover (in generally opposed relationship with the liner), and a non-woven absorbent structure. The absorbent structure has a length, a width, a thickness and opposite major faces. The absorbent structure has binder fibers which are activated to form inter-fiber bonds within the absorbent structure. The absorbent structure also has an absorbent composite. The absorbent composite includes a superabsorbent material and an energy receptive additive. The energy receptive additive of the absorbent composite has a dielectric constant of at least about 4.

### DRAWINGS

The foregoing and other features, aspects and advantages of the present invention will become better understood with regard to the following description, appended claims and accompanying drawings where:

FIG. 1 is a plan view of an absorbent article of the present invention illustrated in the form of a diaper shown unfastened and laid flat;

FIG. 2 is an exploded cross section taken generally in the plane including line 2-2 of FIG. 1;

FIG. 3 is a perspective view of the diaper shown as worn;

FIG. 4 is a longitudinal cross-section of an absorbent structure of the diaper of FIG. 1 taken generally on the longitudinal axis thereof;

FIG. 5 is a schematic perspective of apparatus for forming an absorbent structure of the present invention;

FIG. 6 is an enlarged side elevation of an airforming device of the apparatus of FIG. 5;

FIG. 7 is a fragmentary cross-section of the airforming device of FIG. 6;

FIG. 8 is a schematic perspective of a forming drum and forming surface of the airforming device of FIG. 6;

FIG. 9 is an enlarged schematic of a portion of the forming drum and forming surface;

FIG. 10 is a schematic perspective of a longitudinal cross-section taken through a portion of the forming drum and forming surface;

FIG. 11 illustrates a plot of heating rates for various samples; and

FIG. 12 illustrates a plot of heating rates for various samples.

Corresponding reference characters indicate corresponding parts throughout the several views of the drawings.

### DESCRIPTION

Absorbent Article

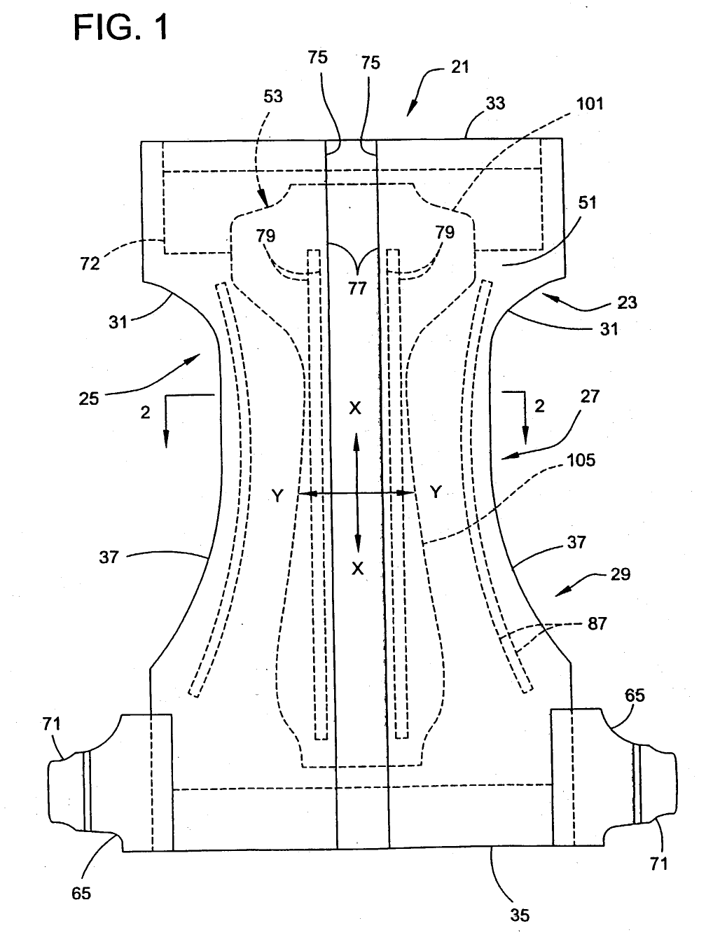

Referring now to the drawings and in particular to FIG. 1, one example of an absorbent article constructed in accordance with the present invention is illustrated in the form of a diaper, which is indicated in its entirety by the reference numeral 21. As used herein, an absorbent article refers to an article which may be placed against or in proximity to the body of a wearer (e.g., contiguous to the body) to absorb and/or retain various waste(s) discharged from the body. Some absorbent articles, such as disposable absorbent articles, are intended to be discarded after a limited period of use instead of being laundered or otherwise restored for reuse. It is contemplated, however, that the principles of the present invention have application in garments (including reusable garments) and other absorbent articles. For example, the principles of the present invention may be incorporated into children's training pants and other infant and child care products, adult incontinence garments and other adult care products, medical garments, sanitary napkins and other feminine care products and the like, as well as surgical bandages and sponges.

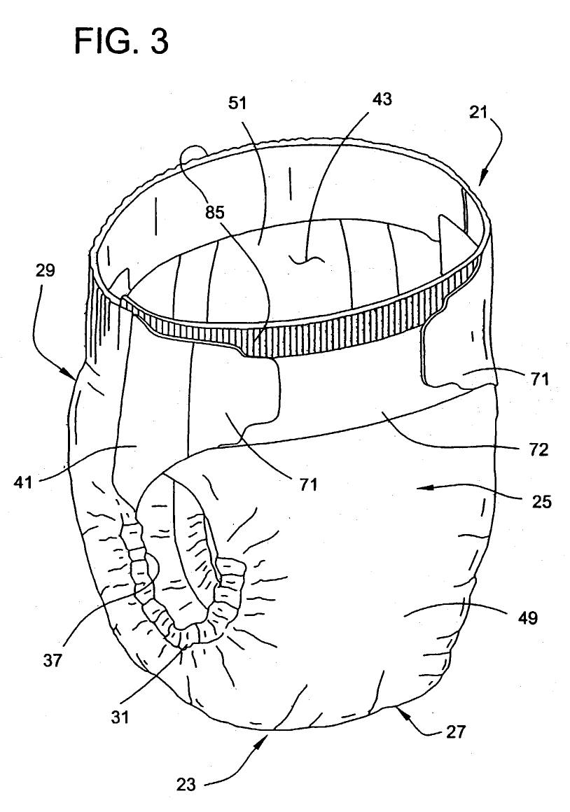

A diaper (21) is shown in FIG. 1 in an unfolded and laid-flat condition to illustrate a longitudinal axis X and a lateral axis Y of the diaper. The diaper (21) generally comprises a central absorbent assembly (23) extending longitudinally from a front (e.g., anterior) region (25) of the diaper through a crotch (e.g., central) region (27) to a back (e.g., posterior) region (29) of the diaper. The central absorbent assembly (23) is generally I-shaped, and more particularly hourglass shaped, and has contoured, laterally opposite side edges (31) and longitudinally opposite front and rear waist edges or ends (designated 33 and 35, respectively). It is understood, however, that the diaper (21) may have other shapes, such as a rectangular shape or a T-shape without departing from the scope of the present invention. The side edges (31) of the diaper (21) extend longitudinally from the front region (25) through the crotch region (27) to the back region (29) for forming transversely spaced leg openings (37) (FIG. 3) of the diaper when worn.

The front region (25) generally includes the portions of the central absorbent assembly (23) which extend over the wearer's lower abdominal region and the back region (29) generally includes the portions of the central absorbent assembly which extend over the wearer's lower back region. The crotch region (27) includes the portion extending longitudinally through the wearer's crotch from the front region (25) to the back region (29) and laterally between the wearer's legs. As worn on the wearer's body (FIG. 3), the diaper (21) further defines a central waist opening (43) and the leg openings (37).

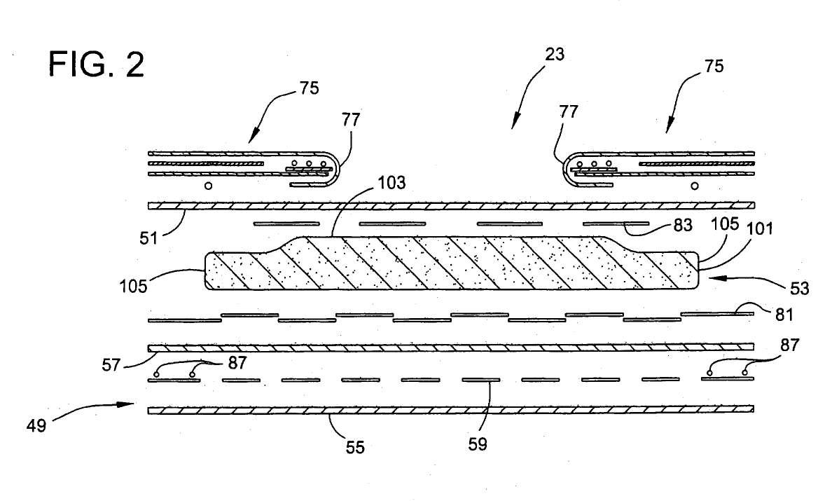

With particular reference to FIG. 2, the central absorbent assembly (23) of the diaper (21) comprises an outer cover (generally indicated at 49), a bodyside liner (51) positioned in facing relation with the outer cover, and an absorbent body (generally indicated at 53) disposed between the outer cover and the liner. The outer cover (49) of the illustrated embodiment generally defines the length and width of the diaper (21). The absorbent body (53) has a length and width which are less than the respective length and width of the outer cover (49) such that the outer cover extends both longitudinally and laterally out beyond the sides and ends of the absorbent body. The bodyside liner (51) may be generally coextensive with the outer cover (49), or may instead overlie an area which is larger (and would thus generally define the length and/or width of the diaper (21)) or smaller than the area of the outer cover (49), as desired. In other words, the bodyside liner (51) is desirably in superposed relation with the outer cover (49) but may not necessarily be coextensive with the outer cover.

In one embodiment, the outer cover (49) is stretchable and may or may not be somewhat elastic. More particularly, the outer cover (49) is sufficiently extensible such that once stretched under the weight of the insulted absorbent body, the outer cover will not retract substantially back toward its original position. However, it is contemplated that the outer cover (49) may instead be generally non-extensible and remain within the scope of this invention.

The outer cover (49) may be a multi-layered laminate structure to provide desired levels of extensibility as well as liquid impermeability and vapor permeability. For example, the outer cover (49) of the illustrated embodiment is of two-layer construction, including an outer layer (55) constructed of a vapor permeable material and an inner layer (57) constructed of a liquid impermeable material, with the two layers being secured together by a suitable laminate adhesive (59). It is understood, however, that the outer cover (49) may instead be constructed of a single layer of liquid impermeable material, such as a thin plastic film constructed of materials such as those from which the inner layer (57) is constructed as described later herein, without departing from the scope of this invention. The liquid impermeable inner layer (57) of the outer cover (49) can be either vapor permeable (i.e., “breathable”) or vapor impermeable.

The bodyside liner (51) is desirably pliable, soft feeling, and nonirritating to the wearer's skin, and is employed to help isolate the wearer's skin from the absorbent body (53). The liner (51) is less hydrophilic than the absorbent body (53) to present a relatively dry surface to the wearer, and is sufficiently porous to be liquid permeable to thereby permit liquid to readily penetrate through its thickness. A suitable bodyside liner (51) may be manufactured from a wide selection of web materials, but is desirably capable of stretching in at least one direction (e.g., longitudinal or lateral). In particular embodiments, the bodyside liner (51) is desirably extensible and capable of extending along with the outer cover (49) for desired fit of the diaper on the wearer.

Fastener tabs (65) (FIGS. 1 and 3) are secured to the central absorbent assembly (23) generally at the back region (29) thereof with the tabs extending laterally out from the opposite side edges (31) of the assembly. The fastener tabs (65) may be attached to the outer cover (49), to the bodyside liner (51), between the outer cover and liner, or to other components of the diaper (21). The tabs (65) may also be elastic or otherwise rendered elastomeric. For example, the fastener tabs (65) may be an elastomeric material such as a neck-bonded laminate (NBL) or stretch-bonded laminate (SBL) material.

Methods of making such materials are well known to those skilled in the art and are described in U.S. Pat. No. 4,663,220 issued May 5, 1987, to Wisneski et al., U.S. Pat. No. 5,226,992 issued Jul. 13, 1993, to Morman, and European Patent Office Publication No. EP 0 217 032 published on Apr. 8, 1987, in the names of Taylor et al., the disclosure of each of which is hereby incorporated herein by reference in a manner that is consistent (i.e., does not conflict) herewith. Examples of articles that include selectively configured fastener tabs are described in U.S. Pat. No. 5,496,298 issued Mar. 5, 1996, to Kuepper et al; U.S. Pat. No. 5,540,796 issued Jul. 30, 1996, to Fries; and U.S. Pat. No. 5,595,618 issued Jan. 21, 1997, to Fries et al., the disclosure of each of which is hereby incorporated herein by reference in a manner that is consistent herewith. Alternatively, the fastener tabs (65) may be formed integrally with a selected diaper component. For example, the tabs (65) may be formed integrally with the inner or outer layer (57, 55) of the outer cover (49), or with the bodyside liner (51).

Fastening components, such as hook and loop fasteners (designated 71 and 72 respectively) are employed to secure the diaper (21) on the body of a child or other wearer. Alternatively, other fastening components (not shown), such as buttons, pins, snaps, adhesive tape fasteners, cohesives, mushroom-and-loop fasteners, or the like, may be employed. Desirably, the interconnection of the fastening components (71, 72) is selectively releasable and re-attachable. In the illustrated embodiment, the hook fasteners (71) are secured to and extend laterally out from the respective fastener tabs (65) at the back region (29) of the diaper (21). However, it is understood that the fastener tabs (65) may be formed of a hook material and thus comprise the hook fasteners (71) without departing from the scope of this invention. The loop fastener (72) of the illustrated embodiment is a panel of loop material secured to the outer cover (49) at the front region (25) of the diaper (21) to provide a “fasten anywhere” mechanical fastening system for improved fastening of the hook fasteners (71) with the loop fastener.

The loop material may include a pattern-unbonded non-woven fabric having continuous bonded areas that define a plurality of discrete unbonded areas. The fibers or filaments within the discrete unbonded areas of the fabric are dimensionally stabilized by the continuous bonded areas that encircle or surround each unbonded area, such that no support or backing layer of film or adhesive is required. The unbonded areas are specifically designed to afford spaces between fibers or filaments within the unbonded areas that remain sufficiently open or large to receive and engage hook elements of the complementary hook fasteners (71). In particular, a pattern-unbonded non-woven fabric or web may include a spunbond non-woven web formed of single component or multi-component melt-spun filaments. For example, the loop material may be a laminated structure including a polyethylene component and a polypropylene component adhesively bonded together with the polypropylene component facing outward away from the outer cover (49) to receive the hook fasteners (71). Examples of suitable pattern-unbonded fabrics are described in U.S. Pat. No. 5,858,515 issued Jan. 12, 1999, to Stokes et al., the entire disclosure of which is hereby incorporated herein by reference in a manner that is consistent herewith.

The diaper (21) shown in FIG. 1 also includes a pair of containment flaps (generally indicated at (75)) configured to provide a barrier to the lateral flow of body exudates. The containment flaps (75) are located generally adjacent the laterally opposite side edges (31) of the diaper (21) and, when the diaper is laid flat as shown in FIGS. 1 and 2, extend inward toward the longitudinal axis X of the diaper. Each containment flap (75) typically has a free, or unattached end (77) free from connection with the bodyside liner (51) and other components of the diaper (21). Elastic strands (79) disposed within the flaps (75) adjacent the unattached ends thereof urge the flaps toward an upright, perpendicular configuration in at least the crotch region (27) of the diaper (21) to form a seal against the wearer's body when the diaper is worn. The containment flaps (75) may extend longitudinally the entire length of the absorbent body (53) or they may extend only partially along the length of the absorbent body. When the containment flaps (75) are shorter in length than the absorbent body (53), the flaps can be selectively positioned anywhere between the side edges (31) of the diaper (21) in the crotch region (27). In a particular aspect of the invention, the containment flaps (75) extend the entire length of the absorbent body (53) to better contain the body exudates.

Such containment flaps (75) are generally well known to those skilled in the art and therefore will not be further described herein except to the extent necessary to describe the present invention. As an example, suitable constructions and arrangements for containment flaps (75) are described in U.S. Pat. No. 4,704,116 issued Nov. 3, 1987, to Enloe, the entire disclosure of which is hereby incorporated herein by reference in a manner that is consistent herewith. The diaper (21) may also incorporate other containment components in addition to or instead of the containment flaps (75). For example, while not shown in the drawings, other suitable containment components may include, but are not limited to, elasticized waist flaps, foam dams in the front, back and/or crotch regions, and the like.

The various components of the diaper (21) are assembled together using a suitable form of attachment, such as adhesive, sonic bonds, thermal bonds or combinations thereof. In the illustrated embodiment, the outer cover (49) and absorbent body (53) are secured to each other with lines of adhesive (81), such as a hot melt or pressure-sensitive adhesive. The bodyside liner (51) is also secured to the outer cover (49) and may also be secured to the absorbent body (53) using the same forms of attachment.

The bodyside liner (51) may be secured to the outer cover (49) at the lateral edge margins of the crotch region (27), but at least the central portion is free of such connection. Rather than being entirely free of such connection, the bodyside liner (51) may be secured to the absorbent body (53) in the crotch region (27) by a light adhesive (83) which will break away in use. Desirably, securement of the bodyside liner (51) to the outer cover (49) is limited to overlying peripheral edge margins of the two to promote independent stretching movement of the liner and cover relative to each other. If the diaper (21) is to be sold in a pre-fastened condition, the diaper may also have passive bonds (not shown) which join the back region (29) with the front region (25).

The diaper (21) can also include a surge management layer (not shown) which helps to decelerate and diffuse surges or gushes of liquid that may be rapidly introduced into the absorbent body (53). Desirably, the surge management layer can rapidly accept and temporarily hold the liquid prior to releasing the liquid to the absorbent structure. In the illustrated embodiment, for example, a surge layer can be located between the absorbent body (53) and the bodyside liner (51). Examples of suitable surge management layers are described in U.S. Pat. No. 5,486,166 issued Jan. 23, 1996, to Bishop et al., and U.S. Pat. No. 5,490,846 issued Feb. 13, 1996, to Ellis et al., the entire disclosure of each of which is hereby incorporated herein by reference in a manner that is consistent herewith.

To provide improved fit and to help further reduce leakage of body exudates from the diaper (21), elastic components are typically incorporated therein, particularly at the waist area and the leg areas. For example, the diaper (21) of the illustrated embodiment has waist elastic components (85) (FIG. 3) and leg elastics (87) (FIGS. 1 and 2). The waist elastic components (85) are configured to gather and shirr the end margins of the diaper (21) to provide a resilient, comfortable close fit around the waist of the wearer and the leg elastics (87) are configured to gather and shirr the side margins of the diaper at the leg openings (37) to provide a close fit around the wearer's legs.

Examples of other diaper (21) configurations suitable for use in connection with the instant application that may or may not include diaper components similar to those described previously are described in U.S. Pat. No. 4,798,603 issued Jan. 17, 1989, to Meyer et al.; U.S. Pat. No. 5,176,668 issued Jan. 5, 1993, to Bernardin; U.S. Pat. No. 5,176,672 issued Jan. 5, 1993, to Bruemmer et al.; U.S. Pat. No. 5,192,606 issued Mar. 9, 1993, to Proxmire et al., U.S. Pat. No. 5,509,915 issued Apr. 23, 1996, to Hanson et al.; U.S. Pat. No. 5,993,433 issued Nov. 30, 1999, to St. Louis et al.; and U.S. Pat. No. 6,248,097 issued Jun. 19, 2001, to Beitz et al., the disclosure of each of which is hereby incorporated herein by reference in a manner that is consistent herewith.

Absorbent Body

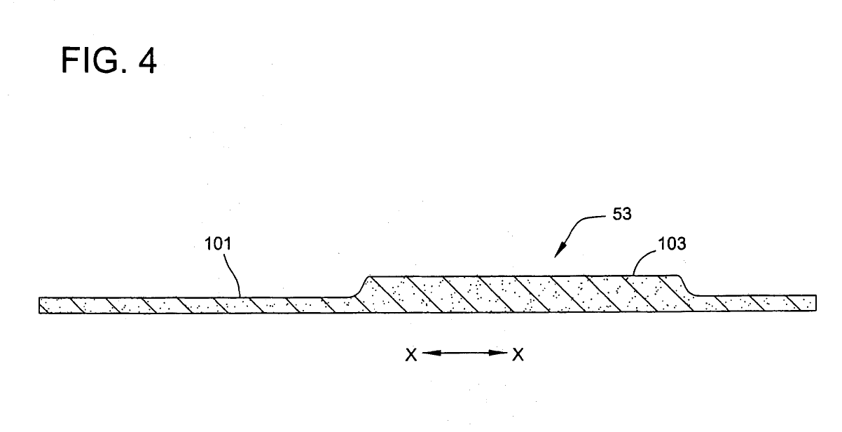

In accordance with the present invention, the absorbent body (53) at least in part comprises a stabilized non-woven absorbent structure (101) (FIG. 4) formed from a mixture of an absorbent composite and binder fibers (broadly, a binding material) which are activatable as will be described to form inter-fiber bonds within the absorbent structure for stabilizing the absorbent structure. Optionally, the absorbent body (53) may also comprise absorbent fibers.

Absorbent Composite

The absorbent composites suitable for use in the present invention include a superabsorbent material covered with an energy receptive additive.

A wide variety of materials can be suitably employed as the superabsorbent material of the absorbent composite. It is desired, however, to employ superabsorbent material in particle form capable of absorbing large quantities of fluids, such as water or urine, and of retaining such absorbed fluids under moderate pressures. It is even more desired to use relatively inexpensive and readily obtainable superabsorbent materials.

By “particle,” “particles,” “particulate,” “particulates,” and the like, it is meant that a material is generally in the form of discrete units. The particles can include granules, pulverulents, powders, or spheres. Thus, the particles can have any desired shape such as, for example, cubic, rod-like, polyhedral, spherical or semi-spherical, rounded or semi-rounded, angular, irregular, etc. Shapes having a large greatest dimension/smallest dimension ratio, like needles, flakes and fibers, are also contemplated for use herein. The use of “particle” or “particulate” may also describe an agglomeration including more than one particle, particulate, or the like.

As used herein, “superabsorbent material,” “superabsorbent materials” and the like are intended to refer to a water-swellable, water-insoluble organic or inorganic material capable, under the most favorable conditions, of absorbing at least about 10 times its weight and, desirably, at least about 15 times its weight in an aqueous solution containing 0.9 weight percent of sodium chloride. Such materials include, but are not limited to, hydrogel-forming polymers which are alkali metal salts of: poly(acrylic acid); poly(methacrylic acid); copolymers of acrylic and methacrylic acid with acrylamide, vinyl alcohol, acrylic esters, vinyl pyrrolidone, vinyl sulfonic acids, vinyl acetate, vinyl morpholinone and vinyl ethers; hydrolyzed acrylonitrile grafted starch; acrylic acid grafted starch; maleic anhydride copolymers with ethylene, isobutylene, styrene, and vinyl ethers; polysaccharides such as carboxymethyl starch, carboxymethyl cellulose, methyl cellulose, and hydroxypropyl cellulose; poly(acrylamides); poly(vinyl pyrrolidone); poly(vinyl morpholinone); poly(vinyl pyridine); and copolymers, and mixtures of any of the above and the like. The hydrogel-forming polymers are desirably lightly cross-linked to render them substantially water-insoluble. Cross-linking may be achieved by irradiation or by covalent, ionic, van der Waals attractions, or hydrogen bonding interactions, for example. A desirable superabsorbent material is a lightly cross-linked hydrocolloid. Specifically, a more desirable superabsorbent material is a partially neutralized polyacrylate salt.

Superabsorbent material employed in the present invention suitably should be able to absorb a liquid under an applied load. For purposes of the present invention, the ability of a superabsorbent material to absorb a liquid under an applied load and thereby perform work is quantified as the Absorbency Under Load (AUL) value. The AUL value is expressed as the amount (in grams) of an approximately 0.9 weight percent saline (sodium chloride) solution absorbed by about 0.160 grams of superabsorbent material when the superabsorbent material is under a load. Common loads include those of about 0.29 pound per square inch, 0.57 pound per square inch, and about 0.90 pound per square inch. Superabsorbent materials suitable for use herein desirably are stiff-geling superabsorbent materials having an AUL value under a load of about 0.29 pound per square inch of at least about 7; alternatively, at least about 9; alternatively, at least about 15; alternatively, at least about 20; alternatively, at least about 24; and, finally, alternatively, at least about 27 g/g. (Although known to those skilled in the art, the gel stiffness or shear modulus of a superabsorbent material is further described in U.S. Pat. No. 5,147,343 issued Sep. 15, 1992, to Kellenberger and/or U.S. Pat. No. 5,601,542 issued Feb. 11, 1997, to Melius et al., the disclosure of each of which is hereby incorporated herein by reference in a manner that is consistent herewith.) Useful superabsorbent materials are well known in the art, and are readily available from various suppliers. For example, FAVOR SXM 880 superabsorbent material is available from Stockhausen, Inc., a business having offices located in Greensboro, N.C., U.S.A.; and DRYTECH 2035 superabsorbent material is available from Dow Chemical Company, a business having offices located in Midland, Mich., U.S.A.

Suitably, the superabsorbent material is in the form of particles which, in the unswollen state, have maximum cross-sectional diameters ranging between about 50 and about 1,000 microns; desirably, between about 100 and about 800 microns; more desirably between about 200 and about 650 microns; and most desirably, between about 300 and about 600 microns, as determined by sieve analysis according to American Society for Testing Materials Test Method D-1921. It is understood that the particles of superabsorbent material may include solid particles, porous particles, or may be agglomerated particles including many smaller particles falling within the described size ranges.

The absorbent composites also include an energy receptive additive. In such an instance, the energy receptive additive is in intimate association with and covering the surface of the superabsorbent material. Suitable energy receptive additives may be in particulate, liquid or semi-liquid form and are capable of becoming excited when subjected to dielectric heating. In addition, suitable energy receptive additives absorb microwave energy efficiently, converting it to heat.

Use of “cover,” “covers,” “covering” or “covered” with regard to an energy receptive additive is intended to indicate that the energy receptive additive extends over the surface of the material being covered to the extent necessary to realize many of the advantages of the present invention. This includes situations where the energy receptive additive extends over at least about 10 percent of the surface of the material being covered; alternatively, at least about 20 percent of the surface of the material being covered; alternatively, over at least about 30 percent of the surface of the material being covered; alternatively, over at least about 40 percent of the surface of the material being covered; alternatively, over at least about 50 percent of the surface of the material being covered; alternatively, over at least about 60 percent of the surface of the material being covered; alternatively, over at least about 70 percent of the surface of the material being covered; alternatively, over at least about 80 percent of the surface of the material being covered; and finally, alternatively, over at least about 90 percent of the surface of the material being covered. The term “surface” and its plural generally refer herein to the outer or the topmost boundary of an object.

As used herein, the phrase “intimate association” and other similar terms are intended to encompass configurations including the following: those where at least a portion of an energy receptive additive is in contact with a portion of the surface of at least one particle of superabsorbent material; and/or those where at least a portion of an energy receptive additive is in contact with a portion of another energy receptive additive such as in, for example, a layered or mixed configuration.

In order to be industrially applicable, a suitable energy receptive additive absorbs energy at the desired frequency (typically between about 0.01 to about 300 GHz) very rapidly, in the range of fractions of a second; alternatively, less than about a quarter of a second; alternatively, less than about a half of a second; and at most about one second.

A suitable energy receptive additive should have a dielectric loss factor that is relatively high. The dielectric loss factor is a measure of how receptive to high frequency energy a material is. The measured value of ε′ is most often referred to as the dielectric constant, while the measurement of ε″ is denoted as the dielectric loss factor. These values can be measured directly using a Network Analyzer with a low power external electric field (i.e., 0 dBm to about +5 dBm) typically over a frequency range of about 300 kHz to about 3 GHz, although Network Analyzers to 20 GHz are readily available. For example, a suitable measuring system can include an HP8720D Dielectric Probe and a model HP8714C Network Analyzer, both available from Agilent Technologies, a business having offices located in Brookfield, Wis., U.S.A. Substantially equivalent devices may also be employed. By definition, ε″ is always positive; however, a value of less than zero is occasionally observed when ε″ is near zero due to the measurement error of the analyzer. The dielectric loss tangent is defined as the calculated ratio of ε″/ε′. This dielectric loss tangent (tan δ) results as the vector sum of the orthogonal real(ε′)and imaginary(ε″)parts of the complex relative permittivity (εᵣ)of a sample. The vector sum of the real and imaginary vectors creates an angle (δ) where tan δ is the analytical geometry equivalent to the ratio of ε″/ε′. Energy receptive additives useful in the present invention typically have a dielectric constant—measured in the frequency range of about 900 to about 3,000 MHz—of at least about 4; alternatively, at least 4; alternatively, at least about 8; alternatively, at least 8; alternatively, at least about 15; or alternatively, at least 15. Stated differently, the energy receptive additives suitable for use in the present invention have a dielectric loss tangent—measured in the frequency range of about 900 to about 3,000 MHz—of at least about 0.15; alternatively, at least 0.15; alternatively, at least about 0.25; alternatively, at least 0.25; alternatively, at least about 0.5; or alternatively, at least 0.5. It should be noted that the dielectric constant and dielectric loss tangent are dimensionless.

Examples of materials that may be suitable energy receptive additives, followed by their dielectric constants are: titanium dioxide (110), hydrogen peroxide at 0° C. (84.2), water at 20° C. (80.4), methyl alcohol at −80° C. (56.6), glycerol at 25° C. (42.5), titanium oxide (40-50), glycol at 25° C. (37), sorbitol at 80° C. (33.5), ethanol at 25° C. (24.3), propanol at 80° C. (20.1), ferrous sulfate at 14° C. (14.2), ferrous oxide at 15.5° C. (14.2), calcium superphosphate (14-15), zircon (12), graphite or high density carbon black (12-15), calcium oxide granules (11.8), barium sulfate at 15.5° C. (11.4), ruby (11.3), silver chloride (11.2), silicon (11-12), hydrogenated castor oil at 27° C. (10.3), magnesium oxide (9.7), alumina (9.3-11.5), anhydrous sodium carbonate (8.4), calcite (8), mica (7), dolomite (6.8-8). Other examples include, but are not limited to, various mixed valent oxides such as magnetite (Fe₃O₄), nickel oxide (NiO) and such; ferrite, tin oxide, carbon, carbon black and graphite; sulfide semiconductors such as FeS₂, CuFeS₂; silicon carbide; various metal powders such as aluminum, iron and the like; various hydrated salts and other salts, such as calcium chloride dihydrate; diatomaceous earth; adipic acids; aliphatic polyesters, e.g., polybutylene succinate and poly(butylene succinate-co-adipate), polymers and co-polymers of polylactic acid, polymers such as PEO and copolymers of PEO, including PEO grafted with polar acrylates; various hygroscopic or water absorbing materials or more generally polymers or copolymers or non-polymers with many sites with—OH groups; other inorganic microwave absorbers including aluminum hydroxide, zinc oxide, barium titanate and other organic absorbers such as polymers containing ester, aldehyde, ketone, isocyanate, phenol, nitrile, carboxyl, vinylidene chloride, ethylene oxide, methylene oxide, epoxy, amine groups, polypyrroles, polyanilines, polyalkylthiophenes, and mixtures thereof.

It should be further noted that the absorbent composites are not limited to the use of only one energy receptive additive, but could also include mixtures of two or more energy receptive additives. As previously indicated, the energy receptive additive may be in particulate form; consequently, it is understood that the particles of energy receptive additive may include solid particles, porous particles, or may be an agglomeration of more than one particle of energy receptive additive. One skilled in the art would readily appreciate the possibility of treating the surface of a particle of energy receptive additive to enhance its ability to efficiently absorb microwave energy. Suitable surface treatments include scoring, etching, and the like. The energy receptive additive may also be in the form of a liquid or semi-liquid. In particular, a solution, dispersion or emulsion of one or more effective energy receptive additives may be formulated. Such a liquid or semi-liquid formulation may be deposited on the surface of superabsorbent material in the form of finely atomized droplets or by any of a variety of other known methods including spraying or blowing in the form of steam, and the like. When so deposited, at least a portion of the energy receptive additive would come into intimate association with and cover at least a portion of the surface of a particle of superabsorbent material.

In various embodiments of the absorbent composites described herein, the intimate association of an energy receptive additive with a superabsorbent material may be achieved with the optional use of an association agent. The association agent usually includes substances that can be applied in liquid or semi-liquid form to either the superabsorbent material or the energy receptive additive. The term “applied” as used herein is intended to include situations where: at least a portion of the surface of a particle of superabsorbent material has an effective amount of association agent on it to facilitate adherence, via mechanical and/or chemical bonding, of at least a portion of the surface of the superabsorbent material to at least a portion of an energy receptive additive; at least a portion of an energy receptive additive has an effective amount of association agent on it to facilitate adherence, via mechanical and/or chemical bonding, of at least a portion of the energy receptive additive to a portion of the surface of a particle of superabsorbent material; and/or at least a portion of an energy receptive additive has an effective amount of association agent on it to facilitate adherence, via mechanical and/or chemical bonding, of at least a portion of an energy receptive additive to a portion of another energy receptive additive. Desirably, the association agent is applied to the selected material in an amount of from about 99:1 to about 1:99, by weight.

The selection of a particular association agent can be made by one skilled in the art and will typically depend upon the chemical composition of the materials to be maintained in intimate association with one another. Desirably, the association agent is suitable for use in applications involving human contact. Thus, the association agent should be non-toxic and non-irritating to humans. A suitable association agent is typically prepared by the formation of a liquid or semi-liquid capable of being generally uniformly atomized. In particular, a solution, dispersion or emulsion including at least one of the association agents identified herein may be prepared. Although the association agent is described herein as being applied as finely atomized droplets, it may be applied to the selected material by any other method such as by spraying in liquid or semi-liquid form, spraying and blowing in the form of steam, and the like.

Several types of association agent are capable of being employed in the absorbent composites described herein. Illustrative association agents suitable for use include, for example: water; volatile organic solvents such as alcohols; aqueous solutions of film-forming materials such as dried milk, lactose, soluble soy protein, and casein; synthetic adhesives such as polyvinyl alcohol; and mixtures thereof. The presence of water in the association agent is particularly effective in predisposing the superabsorbent material to wetting.

The absorbent composites are believed to be suitable for use in a variety of disposable absorbent articles including, but not limited to: health care related products including ostomy products, surgical drapes, gowns, and sterilization wraps; personal care absorbent products such as feminine hygiene products, diapers, training pants, incontinence products and the like; as well as facial tissues. In general, the absorbent composites may be used in a manner similar to that in which other superabsorbent-containing composites have been used: for example, in laminates, in relatively high density cores (i.e., compacted cores, calendered cores, densified cores, etc.), or in relatively low density cores (i.e., not compacted, for example, airlaid cores).

The absorbent composites disclosed herein, however, are believed to provide certain advantages over conventional superabsorbent material. For example, an absorbent composite of the typed described herein may be exposed to microwave energy while minimizing or eliminating the exploding or popping commonly associated with the microwave heating of a particle of superabsorbent material that does not have an energy receptive additive covering its surface. Conventional convective heating of a particle of conventional superabsorbent material causes the water within the particle to move toward the surface of the particle at the water diffusion rate of the particle itself. The passive diffusion rate is believed to be approximately proportional to the material matrix density of the particle. In contrast, the dielectric heating of a particle of conventional superabsorbent material raises the internal temperature of the particle rapidly driving water to the surface via an active transport. Without desiring to be bound by theory, it is believed that the microwave heating of a particle of conventional superabsorbent material during a relatively short activation period drives water to the surface of the particle at a rate sufficient to oftentimes cause the particle to explode or pop.

It is further believe that the absorbent composites described herein may be exposed to microwave energy while minimizing or eliminating the arcing commonly associated with the microwave heating of a particle of superabsorbent material that does not have an energy receptive additive covering its surface. Without desiring to be bound by theory, it is believed that energy receptive additives suitable for use in the absorbent composites absorb energy, such as radio frequency (RF) or microwave energy, more rapidly than the superabsorbent material and thus heat faster than the superabsorbent material. When incorporated into the manufacture of the stabilized absorbent structures (101) of the present invention, the energy receptive additive will heat faster than the superabsorbent material. By heating faster than the superabsorbent material, the energy receptive additive will activate any adjacent binder fibers thereby stabilizing the absorbent structure (101). The absorbent composites therefore allow for the activation of binder fibers to form stabilized absorbent structures (101) at higher speeds, shorter heating times, and lower energy levels. The absorbent composites discussed herein may be prepared in a manner disclosed in U.S. patent application Ser. No. ______, entitled “Microwave Heatable Absorbent Composites,” which was filed contemporaneously herewith on Dec. 18, 2002 (Atty. Docket No. 16,282.1), the entire disclosure of which is incorporated herein by reference in a manner that is consistent herewith.

Energy receptive additives can be receptive to various specific spectra of energy. Just as a black item will absorb more energy and become warmer than the same item colored white when subjected to the same amount of solar energy, energy receptive additives will absorb energy at their specific wavelength, directed at them. One method of providing energy to an energy receptive additive is via dielectric heating (e.g., RF or microwave heating) as hereinafter further described.

Binder Fibers

The binder fibers are desirably activatable, such as upon being heated, to form inter-fiber bonds within the absorbent structure. As used herein, the inter-fiber bonds may be between the binder fibers and the optional absorbent fibers, between the binder fibers and the absorbent composite, and/or among the binder fibers themselves.

In one embodiment, the binder fibers are bicomponent, or multicomponent binder fibers. As used herein, multicomponent binder fibers refers to fibers formed from two (e.g., bicomponent) or more polymers extruded from separate extruders but joined together to form a single fiber. The polymers are arranged in substantially constantly positioned distinct zones across a cross-section of the multi-component fibers and extend continuously along at least a portion of, and more desirably the entire, length of the fiber. The configuration of the multi-component fibers may be, for example, a sheath/core arrangement in which one polymer is surrounded by another, a side-by-side arrangement, a pie arrangement, an “islands-in-the-sea” arrangement or other suitable arrangement. Bicomponent fibers are disclosed in U.S. Pat. No. 5,108,820 issued Apr. 28, 1992, to Kaneko et al., U.S. Pat. No. 4,795,668 issued Jan. 3, 1989, to Krueger et al, U.S. Pat. No. 5,540,992 issued Jul. 30, 1996, to Marcher et al. and U.S. Pat. No. 5,336,552 issued Aug. 9, 1994, to Strack et al. Bicomponent fibers are also taught in U.S. Pat. No. 5,382,400 issued Jan. 17, 1995, to Pike et al. and may be used to produce crimp in the fibers by using the differential rates of expansion and contraction of the two (or more) polymers.

Multicomponent binder fibers as used herein refers to multicomponent fibers in which at least one of the binder fiber components has a melt temperature that is less than at least one other binder fiber component. For example, the binder fiber may be a bicomponent fiber having a sheath/core arrangement in which the sheath component of the binder has a melt temperature that is lower than the melt temperature of the core component of the binder fiber. Upon heating of the binder fiber, the component having the lower melt temperature can fuse and bond to nearby absorbent fibers, superabsorbent material and/or other binder fibers while the other component, or components, remain in a generally unmelted state so as to generally maintain the integrity of the binder fiber.

In other embodiments, the binder fibers can be monofilament or homofilament fibers, biconstituent fibers and the like, as well as combinations thereof.

The binder fibers are desirably constructed of a material, or material, that are readily heated upon exposure to an activation energy, and more particularly the binder fibers are desirably susceptible to dielectric heating via exposure to electromagnetic energy wherein the binder fibers are melted to facilitate forming inter-fiber bonds within the absorbent structure.

It is understood that the binder fibers or other suitable binding material may be activatable other than by dielectric heating, such as by convective or infrared heating or other non-thermal activation, as long as the binder fibers can be incorporated into the absorbent structure (101) prior to activation of the binder fibers to form inter-fiber bonds within the absorbent structure and then subsequently activated to form such inter-fiber bonds to thereby form the stabilized absorbent structure (101).

The binder fibers desirably have a fiber length which is at least about 0.061 mm. The binder fiber length can alternatively be at least about 3 mm and can optionally be at least about 6 mm. In a further feature, the binder-fibers can have a length of up to about 30 mm or more. The binder fiber length can alternatively be up to about 25 mm, and can optionally be up to about 19 mm. In a further aspect, the absorbent structure (101) may include binder fibers having lengths approximating one of the dimensions (e.g., length or width) of the absorbent structure. A relatively long binder fiber length provides an increased number of inter-fiber bond points upon activation of the fibers to help generate improved integrity of the absorbent structure (101).

Synthetic fibers suitable for use as binder fibers in the absorbent structure (101) include those made from synthetic matrix polymers like polyolefins, polyamides, polycaprolactones, polyetheramides, polyurethanes, polyesters, poly (meth) acrylates metal salts, polyether, poly(ethylene-vinyl acetate) random and block copolymers, polyethylene-b-polyethylene glycol block copolymers, polypropylene oxide-b-polyethylene oxide copolymers (and blends thereof) and any other suitable synthetic fibers known to those skilled in the art.

In one embodiment, an energy receptive additive can be included in the binder fibers during production thereof wherein the additive allows the binder fibers to reach their melting temperature much more rapidly than without the additive. This allows inter-fiber bonding in the absorbent structure 101 to occur at a faster rate than without the additive. The additive is desirably capable of absorbing energy at the frequency of electromagnetic energy (e.g., between 0.01 GHz and 300 GHz) rapidly, such as in the range of fractions of a second, desirably less than a quarter of a second and at most about half a second. However, it is contemplated that absorbent structures which involve the absorption of energy and bonding of the binder fibers with the absorbent fibers over a period as long as about 30 seconds are intended to be within the scope of this invention. Melting of the binder fibers will depend on a number of factors such as generator power, additive receptivity, fiber denier, which is generally between 1 and 20, and the composition of the matrix polymer of the binder fiber.

The energy receptive additive may be added to a fiber-making matrix polymer as it is compounded, or coated onto the binder fiber after the fiber is produced. A typical method of compounding the additive with the matrix polymer is with a twin screw extruder, which thoroughly mixes the components prior to extruding them. Upon extrusion, the polymer blend is usually pelletized for convenient storage and transportation.

If the binder fiber is a bicomponent fiber, the energy receptive additive may be added to either or both of the fiber components. The energy receptive additive may also be added to one or more components, preferably the continuous phase, of a biconstituent fiber, and intermittently distributed throughout the length and cross-section of the fiber. If the additive to be used is not compatible with the matrix polymer into which it is to be blended, a “compatibilizer” may be added to enhance the blending. Such compatibilizers are known in the art and examples may be found in U.S. Pat. No. 5,108,827 issued Apr. 28, 1992, to Gessner and U.S. Pat. No. 5,294,482 issued Mar. 15, 1994, to Gessner.

The energy receptive additives can be receptive to various specific spectra of energy. Just as a black item will absorb more energy and become warmer than the same item colored white when subjected to the same amount of solar energy, energy receptive additives will absorb energy at their specific wavelength, directed at them.

A successful energy receptive additive should have a dielectric loss factor, as discussed previously, which is relatively high. The energy receptive additives useful with the binder fibers of the present invention typically can have a dielectric loss factor measured in the RF or microwave frequency of between about 0.5 and 15, more particularly between about 1 and 15, and still more particularly between about 5 and 15. It should be noted that the dielectric loss factor is a dimensionless number. It is preferred that the fiber have a dielectric loss tangent of between about 0.1 and about 1, and more particularly between about 0.3 and about 0.7.

The energy receptive additive may be, for example, carbon black, magnetite, silicon carbide, calcium chloride, zircon, alumina, magnesium oxide, and titanium dioxide. The energy receptive additive may be present in an amount between 2 and 40 weight percent, and more particularly between 5 and 15 weight percent. The binder fibers may be crimped, extendible and/or elastic.

Synthetic fibers incorporating such energy receptive additives are discussed at greater length in co-assigned U.S. patent application Ser. No. 10/034,079 filed Dec. 20, 2001, and entitled “Targeted Bonding Fibers for Stabilized Absorbent Structures,” the entire disclosure of which is hereby incorporated herein by reference in a manner that is consistent herewith. Absorbent structures incorporating binder fibers having such energy receptive additives are discussed in co-assigned U.S. patent application Ser. No. 10/033,860 filed Dec. 20, 2001 and entitled “Targeted On-Line Stabilized Absorbent Structures.”

In addition to the binder fibers having an energy receptive additive, or as an alternative thereto, the binder fibers (or at least one binder fiber component thereof where the binder fiber is a multicomponent fiber) may be constructed to have a relatively low melting temperature, such as less than about 200° C., more desirably less than about 150° C., even more desirably less than about 110° C., still more desirably less than about 90° C., and most desirably less than about 80° C. In such an instance, the absorbent fibers, if present, and the absorbent composite of the absorbent structure (101) can act as a source of heat to indirectly transfer energy to melt the low melting temperature binder fibers. The absorbent fibers thus act as an energy receptive material, and are excited to melt the adjacent low melting temperature polymers of the binder fibers for bonding to the absorbent fibers, to the absorbent composite and/or to each other. This melting will depend on a number of factors such as generator power, moisture content, specific heat, density of the absorbent structure (101) materials, fiber denier, which is generally between 1 and 20, and the composition and concentration of the low melting temperature polymers of the binder fibers.

The low melting temperature binder fibers desirably have a low specific heat to allow rapid heating and cooling of the absorbent structure (101). The low specific heat is useful during the heating cycle since the heat absorbed by the binder fiber before melting is relatively low. The low specific heat is also useful during subsequent cooling of the absorbent structure (101), since the heat to be removed from the binder fiber material to cause it to solidify and stabilize the absorbent structure will be lower. A suitable specific heat range of the binder fiber is in the range of about 0.1 to about 0.6 calories/gram.

The binder fibers also desirably have a high thermal conductivity to enable rapid transfer of heat therethrough. Thermal conductivity is proportional to density and heat capacity/specific heat capacity of the binder fiber material. It is beneficial to achieve higher thermal conductivity using fibers with relatively high density. For example, the binder fibers desirably have a density of more than about 0.94 grams/cubic centimeter (g/cc). This is helpful in accelerating the heating and cooling cycles during activation of the binder fibers to stabilize the absorbent structure (101). It is preferred that the thermal conductivity of the binder fibers be greater than about 0.1 joules-sec⁻¹-mole⁻¹-degree Kelvin⁻¹.

Materials having a low melting enthalpy are also desirable for use as the binder fibers. The low melting enthalpy reduces the energy requirement for transformation of the binder fiber from a solid to a molten state during heating thereof and from the molten state back to a solid state during subsequent cooling. As an example, the melting enthalpy of the binder fibers is desirably less than about 100 joules/gram, more particularly less than about 75 joules/gm and still more particularly less than about 60 joules/gm.

The binder fibers also desirably have a low melt viscosity after activation, i.e., once the fiber is transformed from its solid to its generally molten state. This enables the binder fiber material to flow to the junction points between the binder fibers and the absorbent fibers, the binder fibers and the absorbent composites, and/or other binder fibers for forming stable inter-fiber bonds. As an example, it is desired that the melt viscosity of the binder fibers be less than about 100,000 centipoise, more particularly less than about 20,000 centipoise and most particularly less than about 10,000 centipoise.

The binder fibers also desirably have adequate surface energy to be wettable by fluid to be absorbed by the absorbent structure (101). This wettability is not required in all applications, however, and may be accomplished using various surfactants known to those skilled in the art if the binder fiber is not intrinsically wettable.

Suitable binder fibers having a low melting temperature may be made from polyethylene-polyvinyl alcohol (PE-PVA) block or random copolymers, polyethylene-polyethylene oxide (PE-PEO) block/graft copolymers, polypropylene-polyethylene oxide (PP-PEO) block/graft copolymers, polyester, polycaprolactone, polyamide, polyacrylates, polyurethane (ester or ether based). The melting point can be adjusted by adjusting the content of VA or PEO (for those polymers with VA and PEO) or the configuration. The binder fiber material can be made by compounding with a twin extruder, Sigma mixer or other compounding equipment and then made into fibers by conventional non-woven processes like meltblowing and spunbonding.

As an example, absorbent structures incorporating such low melting temperature binder fibers are discussed in co-assigned U.S. application Ser. No. 10/034,021, filed Dec. 20, 2002, and entitled “Absorbent Structures Having Low Melting Fibers,” the entire disclosure of which is hereby incorporated herein by reference in a manner that is consistent herewith.

A number of other polymers and sensitizers may also, or may alternatively, be used with the energy receptive additives in making the binder fibers. Specifically selecting and/or positioning moieties along the polymer chain can affect the dielectric loss factor of the polymer and enhance the responsiveness of the polymer to electromagnetic energy. These include polymer composites from blend, block, graft, random copolymers, ionic polymers and copolymers and metal salts. Desirably, the presence of one or more moieties along the polymer chain causes one or more of the following: (1) an increase in the dipole moments of the polymer; and (2) an increase in the unbalanced charges of the polymer molecular structure. Suitable moieties include, but are not limited to, aldehyde, ester, carboxylic acid, sulfonamide and thiocyanate groups.

The selected moieties may be covalently bonded or ionically attached to the polymer chain. As discussed above, moieties containing functional groups having high dipole moments are desired along the polymer chain. Suitable moieties include, but are not limited to, urea, sulfone, amide, nitro, nitrile, isocyanate, alcohol, glycol and ketone groups. Other suitable moieties include moieties containing ionic groups including, but are not limited to, sodium, zinc, and potassium ions.

For example, a nitro group may be attached to an aryl group within the polymer chain. It should be noted that the nitro group may be attached at the meta or para position of the aryl group. Further, it should be noted that other groups may be attached at the meta or para position of the aryl group in place of the nitro group. Suitable groups include, but are not limited to, nitrile groups. In addition to these modifications, one could incorporate other monomer units into the polymer to further enhance the responsiveness of the resulting polymer. For example, monomer units containing urea and/or amide groups may be incorporated into the polymer.

Suitable moieties include aldehyde, ester, carboxylic acid, sulfonamide and thiocyanate groups. However, other groups having or enhancing unbalanced charges in a molecular structure can also be useful; or a moiety having an ionic or conductive group such as, e.g., sodium, zinc, and potassium ions. Other ionic or conductive groups may also be used.

Specific combinations include low density PE/polyethylene-polyvinylacetate block copolymer, LDPE/polyethylene glycol, PE/polyacrylates, polyethylene-vinyl acetate copolymer, polyester, polyurethane, polyacrylates, polyethylene glycol (PEG), polyacrylamide (PAA), polyethylenimine (PEEM), polyvinyl acetate (PVAC), polyvinyl alcohol (PVA), polymethylacylic acid-sodium salt (PMA-Na), polyacylic acid sodium salt (PA-Na), and poly (styrene solfonate-co-methyl acylic acid) sodium salt (P (SS-co-MA)-Na), and polymers of terephthalic acid, adipic acid and 1, 4 butanediol, and polybutylene succinate copolymers. Other materials include polymers of terephtalic acid, adipic acid and 1,4-butanediol, sold by BASF Corporation under the name ECOFLEX® or by Eastman Chemical Co. under the name Eastar BiO™ copolyester. Blends and grafted copolymers of the above listed polymers are also suitable.

Absorbent Fibers

The optional absorbent fibers may be provided by various types of wettable, hydrophilic fibrous material. For example, suitable absorbent fibers include naturally occurring organic fibers composed of intrinsically wettable material, such as cellulosic fibers; synthetic fibers composed of cellulose or cellulose derivatives, such as rayon fibers; inorganic fibers composed of an inherently wettable material, such as glass fibers; synthetic fibers made from inherently wettable thermoplastic polymers, such as particular polyester or polyamide fibers; and synthetic fibers composed of a nonwettable thermoplastic polymer, such as polypropylene fibers, which have been hydrophilized by appropriate means. The fibers may be hydrophilized, for example, by treatment with silica, treatment with a material that has a suitable hydrophilic moiety and is not readily removable from the fiber, or by sheathing the nonwettable, hydrophobic fiber with a hydrophilic polymer during or after the formation of the fiber. For the present invention, it is contemplated that selected blends of the various types of fibers mentioned above may also be employed.

Suitable sources of absorbent fibers may include cellulosic fibers including: wood fibers, such as bleached kraft softwood or hardwood, high-yield wood fibers, and ChemiThermoMechanical Pulp fibers; bagasse fibers; milkweed fluff fibers; wheat straw; kenaf; hemp; pineapple leaf fibers; or peat moss. High-yield fibers, such as BCTMP (Bleached ChemiThermal Mechanical Pulp) fibers, can be flash-dried and compressed into densified pads. The high-yield fiber can expand to a higher loft when wetted, and can be used for the absorbent fiber material. Other absorbent fibers, such as regenerated cellulose and curled chemically stiffened cellulose fibers may also be densified to form absorbent structures that can expand to a higher loft when wetted.

As an example, suitable wood pulps include standard softwood fluffing grade such as NB-416 (Weyerhaeuser Corporation, Tacoma, Wash., U.S.A.) and CR-1654 (US Alliance Pulp Mills, Coosa, Ala., U.S.A.), bleached kraft softwood or hardwood, high-yield wood fibers, ChemiThermoMechanical Pulp fibers and Bleached Chemithermal Mechanical Pulped (BCTMP). Pulp may be modified in order to enhance the inherent characteristics of the fibers and their processability. Curl may be imparted to the fibers by conventional methods including chemical treatment or mechanical twisting. Pulps may also be stiffened by the use of crosslinking agents such as formaldehyde or its derivatives, glutaraldehyde, epichlorohydrin, methylolated compounds such as urea or urea derivatives, dialdehydes such as maleic anhydride, non-methylolated urea derivatives, citric acid or other polycarboxylic acids. Some of these agents are less preferable than others due to environmental and health concerns.

Pulp may also be stiffened by the use of heat or caustic treatments such as mercerization. Examples of these types of fibers include NHB416 which is a chemically crosslinked southern softwood pulp which enhances wet modulus, available from the Weyerhaeuser Corporation of Tacoma, Wash., U.S.A. Other useful pulps are debonded pulp (NF405) also from Weyerhaeuser. HPZ3 from Buckeye Technologies, Inc of Memphis, Tenn., U.S.A., has a chemical treatment that sets in a curl and twist, in addition to imparting added dry and wet stiffness and resilience to the fiber. Another suitable pulp is Buckeye HPF2 pulp and still another is IP SUPERSOFT® from International Paper Corporation. Suitable rayon fibers are 1.5 denier Merge 18453 fibers from Tencel Incorporated of Axis, Ala., U.S.A.

Specifically, hydrophilic fibers can be formed from an intrinsically hydrophilic polymer such as a block copolymer of nylon, e.g., nylon-6, and apolyethylene oxide diamine. Such block copolymers are commercially available from Allied-Signal, Inc., under the tradename HYDROFIL. The hydrophilic fiber may also be formed from a water-swellable, substantially water-insoluble superabsorbent polymeric material such as a thermoplastic material described in U.S. Pat. No. 4,767,825 issued Aug. 30, 1988, to Pazos, et al.

Dielectric Heating

Dielectric heating is the term applied to the generation of heat in non-conducting materials by their losses when subject to an alternating electric field of high frequency. For example, the frequency of the electric field desirably ranges from about 0.01 to about 300 GHz (billion cycles/sec). Heating of non-conductors by this method is extremely rapid. This form of heating is applied by placing the non-conducting material between two electrodes, across which the high-frequency voltage is applied. This arrangement in effect constitutes an electric capacitor, with the load acting as the dielectric. Although ideally a capacitor has no losses, practical losses do occur, and sufficient heat is generated at high frequencies to make this a practical form of heat source.

The frequency used in dielectric heating is a function of the power desired and the size of the object being heated. Practical values of voltages applied to the electrodes are 2000 to 5000 volts/in of thickness of the object. The source of power is by electronic oscillators that are capable of generating the very high frequencies desirable.

RF heating occurs at about 27 MHz and heats by providing about half the total power delivered as ionic conduction to the molecules within the workpiece, with the remainder of the power delivered as dipolar molecular rotation. Microwave heating is dielectric heating at still higher frequencies. The predominate frequencies used in industrial microwave heating are 915 and 2450 MHz, although other frequencies may be used and particular energy receptive additives may be found to be receptive at only particular frequencies. Microwave heating is about 10 to about 100 times higher in frequency than the usual dielectric heating, resulting in a lower voltage requirement if the dielectric loss is constant, although the dielectric loss is generally higher at microwave frequencies.

Absorbent Structure

The absorbent structure (101) of the present invention is desirably of unitary construction. As used herein, the unitary construction of the absorbent structure (101) means that the absorbent structure is a single non-woven web or layer comprising a mixture of binder fibers and absorbent composite. Optionally, the absorbent structure may comprise a mixture of absorbent fibers, binder fibers and absorbent composite. In the illustrated embodiment of FIGS. 1-4, a single absorbent structure (101) comprises substantially the entire absorbent body (53) of the diaper (21) (i.e., the dimensions of the absorbent structure substantially define the dimensions of the absorbent body). However, it is contemplated that the absorbent body (53) may comprise more than one layer, wherein at least one of the layers is an absorbent structure (101) of the present invention, and remain within the scope of this invention as long as the absorbent structure is itself of unitary construction.

As an example, in one embodiment the absorbent structure (101) is made by first forming or otherwise collecting the binder fibers and the absorbent composite into a unitary structure having a desired shape, contour and/or material distribution prior to activation of the binder fibers (e.g., prior to inter-fiber bonding within the absorbent structure) to define a non-woven, generally pre-stabilized absorbent structure. The binder fibers are subsequently activated to form inter-fiber bonds within absorbent structure to thereby stabilize the absorbent structure.

Alternatively, the absorbent structure (101) is made by first forming or otherwise collecting the binder fibers, the absorbent composite and the absorbent fibers into a unitary structure having a desired shape, contour and/or material distribution prior to activation of the binder fibers (e.g., prior to inter-fiber bonding within the absorbent structure) to define a non-woven, generally pre-stabilized absorbent structure. The binder fibers are subsequently activated to form inter-fiber bonds within absorbent structure to thereby stabilize the absorbent structure.

Optionally, a substantially hydrophilic tissue wrapsheet (not illustrated) may be employed to help maintain the integrity of the absorbent structure (101), or the entire absorbent body (53). The tissue wrapsheet is typically placed about the absorbent structure or the absorbent body over at least the two major facing surfaces thereof and is composed of an absorbent cellulosic material, such as creped wadding or a high wet-strength tissue. The tissue wrapsheet can also be configured to provide a wicking layer that helps to rapidly distribute liquid to the absorbent fibers within the absorbent body (53). The wrapsheet material on one side of the absorbent body may be bonded to the wrapsheet located on the opposite side of the fibrous mass to effectively entrap the absorbent body.

In one embodiment, the material composition of the pre-stabilized absorbent structure (101) (e.g., prior to activation of the binder fibers) may be from about 0.1 to about 60 weight percent binder fiber, from about 0 to about 80 weight percent absorbent composite, and from about 5 to about 98 weight percent absorbent fibers. More particular embodiments may have from about 2 to about 10 weight percent binder fiber, from about 30 to about 70 weight percent superabsorbent material and from about 30 to about 70 weight percent absorbent fiber. In other embodiments, the pre-stabilized absorbent structure may have from about 0.1 to about 5 weight percent binder fiber.

In another embodiment, the pre-stabilized absorbent structure (101) can include an amount of binder fibers which is at least about 1 weight percent with respect to the total weight of the absorbent structure. The amount of binder fibers can alternatively be at least about 3 weight percent, and can optionally be at least about 5 weight percent. In other aspects, the amount of binder fibers can be up to a maximum of about 30 weight percent, or more. The amount of binder fibers can alternatively be up to about 20 weight percent, and can optionally be up to about 5 weight percent.

The binder fibers, absorbent composite and, if present, the absorbent fibers are desirably distributed within the absorbent structure generally across the full width of the absorbent structure, along the full length thereof and throughout the thickness thereof. However, the concentration of absorbent fibers, binder fibers and/or absorbent composite within the absorbent structure (101) may be non-uniform: i) across the width of the absorbent structure, ii) along the length of the absorbent structure, and/or iii) along the thickness or z-direction (127) of the absorbent structure. For example, a heavier concentration of absorbent fibers, binder fibers and/or absorbent composite may be disposed in different strata (e.g., in the z-direction) or in different regions (e.g., along the length or across the width) of the absorbent structure.

It is also contemplated that one or more strata or regions of the absorbent structure 101 may be devoid of binder fibers and/or absorbent composite, as long as the absorbent structure is of unitary construction and includes binder fibers in at least a portion of the structure. It is further contemplated that binder fibers constructed of different materials may be disposed in different strata or regions of the absorbent structure 101 without departing from the scope of this invention.

In the embodiments described, one or more strata or regions of the absorbent structure (101) may be substantially devoid of absorbent fibers, as long as the absorbent structure is of unitary construction and includes binder fibers, in at least a portion of the structure, and the absorbent composite disclosed herein. In any such embodiments, the unitary construction of the absorbent structure 101 means that the absorbent structure is at least a single non-woven web or layer comprising a mixture of binder fibers and absorbent composite. Referring again to the embodiment illustrated in FIGS. 1-4, a single absorbent structure 101 comprises substantially the entire absorbent body (53) of the diaper (21) (i.e., the dimensions of the absorbent structure substantially define the dimensions of the absorbent body). However, it is contemplated that the absorbent body (53) may comprise more than one layer, wherein at least one of the layers is an absorbent structure (101) of the present invention, and remain within the scope of this invention as long as the absorbent structure is itself of unitary construction. In embodiments described herein as substantially devoid of absorbent fibers, the material composition of the pre-stabilized absorbent structure (101) (e.g., prior to exposure to high-frequency energy such as microwave energy) may have about 1; alternatively, about 3; alternatively, about 5; alternatively, about 10; alternatively, about 15; alternatively, about 20; alternatively, about 25; alternatively, about 30; alternatively, about 40; alternatively, about 50; alternatively, about 60; alternatively, about 70; alternatively, about 75; alternatively about 80; alternatively, about 85; alternatively, about 90; and finally, alternatively, about 95 weight percent binder fibers. The pre-stabilized versions of absorbent structure 101 may also have about 5; alternatively, about 10; alternatively, about 15; alternatively, about 20; alternatively, about 25; alternatively, about 30; alternatively, about 40; alternatively, about 50; alternatively, about 60; alternatively, about 70; alternatively, about 75; alternatively about 80; alternatively, about 85; alternatively, about 90; alternatively, about 95; alternatively, about 97; and finally, alternatively, about 99 weight percent absorbent composite.

The average basis weight of the pre-stabilized absorbent structure (101) is desirably in the range of about 30 to about 2500 grams/square meter (gsm), more desirably within the range of about 50 to about 2000 gsm, and even more desirably within the range of about 100 to about 1500 gsm. The pre-stabilized absorbent structure (101) can also be formed to have a non-uniform basis weight across its width or along its length, with one or more high basis weight regions, and one or more low basis weight regions. In at least one high basis weight region, at least a significant portion of the absorbent structure (101) can have a composite basis weight which is at least about 700 gsm. The high basis weight region can alternatively have a basis weight of at least about 750 gsm, and can optionally have a basis weight of at least about 800 gsm. In other aspects, the high basis weight region of the absorbent structure (101) can have a composite basis weight of up to about 2500 gsm or more. The high basis weight region can alternatively have a basis weight of less than or equal to about 2000 gsm, and more particularly less than or equal to about 1500 gsm.

In another aspect of the present invention, the absorbent structure (101) formed prior to activation of the binder fibers may have a density which is at least a minimum of about 0.01 g/cc as determined at a restraining pressure of 1.38 KPa (0.2 psi). The density can alternatively be at least about 0.02 g/cc, and can optionally be at least about 0.03 g/cc. In other aspects, the density may be up to a maximum of about 0.12 g/cc, or more. The density can alternatively be up to about 0.11 g/cc, and can optionally be up to about 0.1 g/cc. In one embodiment, the density of the pre-stabilized absorbent structure is substantially uniform throughout the absorbent structure. In another embodiment, the density is non-uniform across the width of the absorbent structure and/or along the length of the absorbent structure.

As used throughout the present specification, the term “non-uniform” as used in reference to a particular characteristic or feature of the absorbent structure, is intended to mean that the characteristic or feature is non-constant or otherwise varies within the absorbent structure in accordance with a pre-determined non-uniformity, e.g., an intended non-uniformity that is greater than non-uniformities resulting from normal processing and tolerance variations inherent in making absorbent structures. The non-uniformity may be present as either a gradual gradient or as a stepped gradient, such as where the concentration, basis weight and/or density changes abruptly from one strata or region to an adjacent strata or region within the absorbent structure, and may occur repeatedly within the absorbent structure or may be limited to a particular portion of the absorbent structure.

The pre-stabilized absorbent structure (101) may also be formed to have a thickness which is non-uniform along the length of the absorbent structure and/or across the width of the absorbent structure. The thickness is the distance between the major faces the absorbent structure, as determined in a local z-direction of the absorbent structure directed perpendicular to the planes of the major faces thereof at the location at which the thickness is determined. A variation in thickness may be present as a gradual or otherwise sloped change in thickness or as a stepped change in thickness whereby the thickness changes abruptly from one portion of the absorbent structure to an adjacent portion.

Accordingly, one or more portions of the absorbent structure (101) can have a relatively lower thickness, and other portions of the absorbent structure can have a relatively higher thickness. For example, in the illustrated embodiment, a portion (103) (FIGS. 2 and 4) of the absorbent structure (101) which forms the absorbent body (53) of the diaper (21) is substantially thicker than the rest of the absorbent structure and corresponds generally to the front region (25) of the diaper to provide a targeted area of increased absorption capacity. The thicker portion (103) of the absorbent structure (101) extends lengthwise less than the full length of the absorbent structure and is spaced longitudinally inward of the longitudinal ends of the structure. As shown in FIG. 2 the thicker portion (103) is also centrally positioned between the side edges (105) of the absorbent structure and spaced laterally inward from the side edges thereof.

Additionally, or alternatively, the pre-stabilized absorbent structure (101) may be formed to have a non-uniform width along the length of the absorbent structure. The width is the distance between the side edges of the absorbent structure, as determined in a direction parallel to the Y-axis of the absorbent structure. A variation in width may be present as a gradual or otherwise sloped change in width or as a stepped change in which the width changes abruptly from one portion of the absorbent structure to an adjacent portion. As an example, the absorbent structure (101) may have any of a number of shapes, including rectangular, I-shaped, or T-shaped and is desirably narrower in the crotch region (27) than in the front or back regions (25, 29) of the diaper (21). As illustrated in phantom in FIG. 1, the shape of the absorbent body (53) is defined by the absorbent structure (101) and is generally T-shaped, with the laterally extending crossbar of the “T” generally corresponding to the front region (25) of the diaper (21) for improved performance, especially for male infants.

It is understood, however, that the pre-stabilized absorbent structure (101) may have a substantially uniform thickness and/or may have a substantially uniform width, i.e., the side edges (105) of the absorbent structure are substantially straight and in generally parallel relationship with each other along the length of the absorbent structure.

The absorbent structure (101) is formed in accordance with a desired method for making such an absorbent structure whereby the absorbent composite, binder fibers and optional absorbent fibers are collected on a forming surface while the binder fibers are in a pre-activated condition. The absorbent structure (101) is thus formed as a unitary structure having a desired shape and contour (e.g., a desired length, width and/or thickness profile) before activation of the binder fibers occurs, i.e., before inter-fiber bonding occurs within the absorbent structure. The distribution of the absorbent composite and optional absorbent fibers within the pre-stabilized absorbent structure (101) may also be controlled during formation thereof so that the concentration of materials, basis weight and/or density is substantially non-uniform prior to activation of the binder fibers. The orientation of the absorbent composite, binder fibers and optional absorbent fibers within the absorbent structure is desirably generally random following formation of the pre-stabilized absorbent structure, including at the major faces, side edges and longitudinal ends of the absorbent structure.

The binder fibers are then activated to form inter-fiber bonds with the absorbent composite, other binder fibers and/or the optional absorbent fibers to stabilize the absorbent structure (101). More particularly, in one embodiment the pre-stabilized absorbent structure (101) is exposed to high-frequency electromagnetic energy (e.g., microwave radiation, RF radiation, etc.) to melt the binder fibers for inter-fiber bonding with the absorbent composite and optional absorbent fibers, and then cooled to generally solidify the binder fibers to thereby secure the inter-fiber bonds between the binder fibers and the absorbent composite, and the binder fibers and the optional absorbent fibers, if present.

The absorbent structure desirably remains unmolded during and after activation of the binder fibers. As used herein, the term unmolded during and after activation of the binder fibers means that the binder fibers are not subjected to an operation in which the shape and/or orientation thereof within the absorbent structure, and particularly at the major faces, side edges and longitudinal ends of the absorbent structure, is changed as a result of pressure being applied to the binder fibers while the binder fibers are heated to a generally molten or otherwise activated state. For example, in typical molding operations, the absorbent structure or at least one or both major faces of the absorbent structure is pressed against or within a mold during or after heating of the binder fibers, or the mold itself may be heated so as to heat the binder fibers. Such a molding process forces a reorientation of the absorbent structure fibers to a generally non-random orientation and, and may also re-shape or even emboss the major surfaces of the absorbent structure. Because the absorbent structure (101) remains unmolded during and after activation of the binder fibers, the orientation of fibers within the absorbent structure, including at the major faces, side edges and longitudinal ends thereof, remains generally random during and after activation of the binder fibers to stabilize the absorbent structure.

Following stabilization of the absorbent structure (101), the structure may have substantially the same shape, contour, material distribution and other characteristics as the pre-stabilized absorbent structure. The stabilized absorbent structure (101) is desirably sufficiently strong to support a peak tensile load which is at least a minimum of about 100 grams per inch (g/inch) of cross-directional (Y-axis) width of the absorbent structure. The stabilized absorbent structure (101) strength can alternatively be at least about 200 g/inch, and can optionally be at least about 500 g/inch. In other aspects, the absorbent structure (101) strength can be up to a maximum of about 10,000 g/inch, or more. The strength can alternatively be up to about 5000 g/inch, and can optionally be up to about 2000 g/inch. In determining the strength of the stabilized absorbent structure (101), any previously formed, separately provided reinforcing component should be excluded from the determination. Such reinforcing components (not shown) may, for example, be provided by a scrim, a continuous filament fiber, a yarn, an elastic filament, a tissue, a woven fabric, a non-woven fabric, an elastic film, a polymer film, a reinforcing substrate, or the like, as well as combinations thereof.

The stabilized absorbent structure (101) can be configured to have a strength sufficient to support a peak tensile load which is significantly greater than the peak tensile load that can be supported by the absorbent structure prior to activation of the binder fibers. In a particular aspect, the absorbent structure (101) can be configured to have sufficient strength to support a peak tensile load which is at least about 100% greater than the peak tensile load that can be supported by the absorbent structure prior to activation of the binder fibers. The stabilized structure (101) can alternatively be configured to support a peak tensile load which is at least about 200% greater. Optionally, the stabilized structure (101) can be configured to support a peak tensile load which is at least about 300% greater. The percentage of increase in the supported peak-load can be determined by the formula:

100*(F2−F1)/F1;

where:

F1=the peak tensile load that can be supported by the absorbent structure (101) prior to activation of the binder fibers; and

F2 =the peak tensile load that can be supported by the stabilized absorbent structure.

The peak load that can be supported by an absorbent structure (101) can be determined by employing TAPPI Test Method Number T 494 om-96 entitled “Tensile Properties of Paper and Paperboard” (using constant rate of elongation apparatus) dated 1996. The test sample has a width of 1 inch (2.54 cm), and a length of 6 inch (15.24 cm). The jaws used were INSTRON part number 2712-001 (available from Sintech, Inc., a business having offices in Research Triangle Park, N.C., U.S.A.), and were arranged with an initial separation distance of 5 inch (12.7 cm). The cross-head speed was 12.7 mm/min, and the testing employed a MTS Systems Corp. model RT/1 testing machine controlled by TESTWORKS version 4.0 software, which are available from MTS Systems Corp., a business having office in Eden Prairie, Minn., USA. Substantially equivalent equipment may optionally be employed.

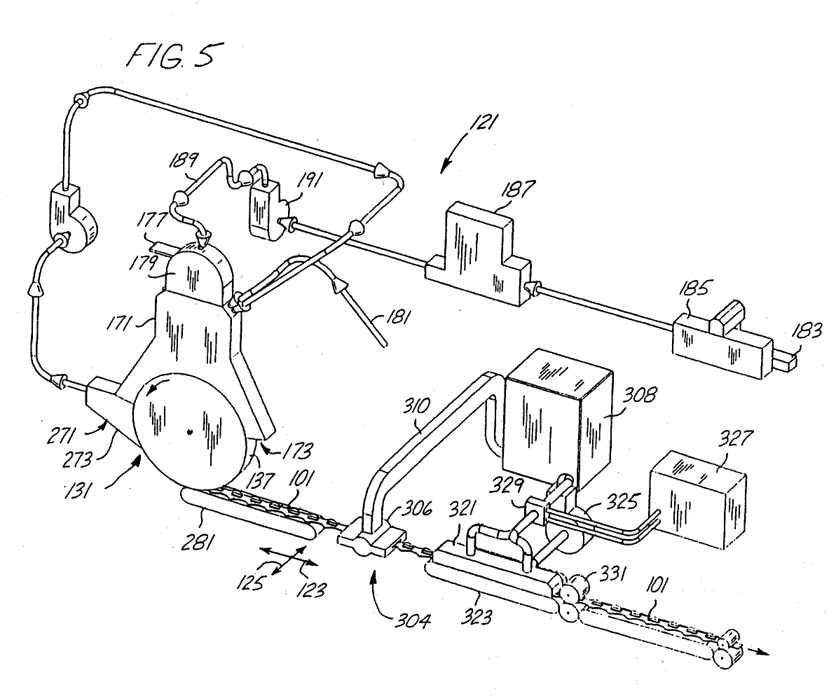

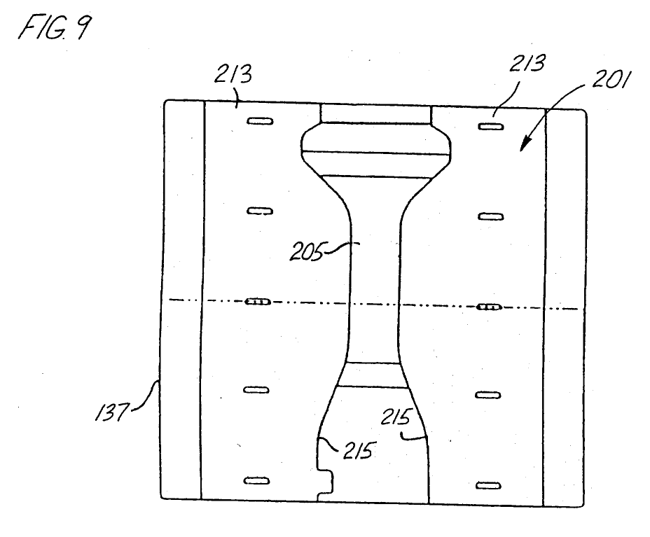

FIGS. 5-10 illustrate one embodiment of apparatus, generally indicated at (121), for making a stabilized absorbent structure (101) in accordance with the present invention and the above-described method. The apparatus (121) has an appointed lengthwise or machine-direction (123), an appointed widthwise or cross-direction (125) which extends transverse to the machine direction, and an appointed thickness or z-direction (127). For the purposes of the present specification, the machine-direction (123) is the direction along which a particular component or material is transported lengthwise or longitudinally along and through a particular, local position of the apparatus. The cross-direction (125) lies generally within the plane of the material being transported through the process, and is aligned perpendicular to the local machine-direction (123). The z-direction (127) is aligned substantially perpendicular to both the machine-direction (123) and the cross-direction (125), and extends generally along a depth-wise, thickness dimension. In the illustrated embodiment, the machine direction (123) corresponds to the longitudinal X-axis of the diaper (21) of FIG. 1 and the cross-direction (125) corresponds to the lateral Y-axis of the diaper.

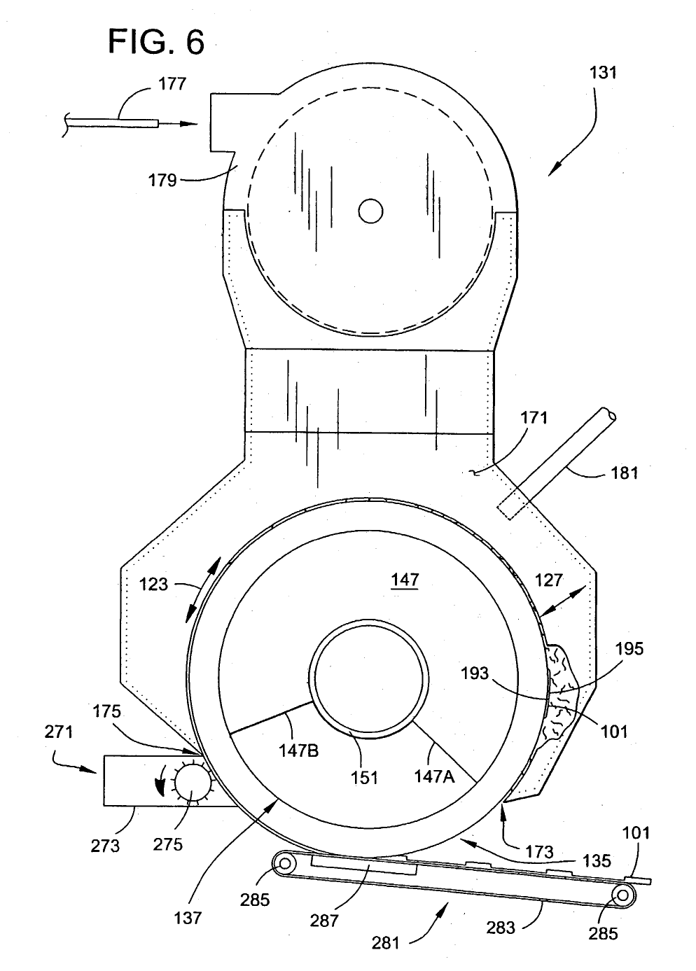

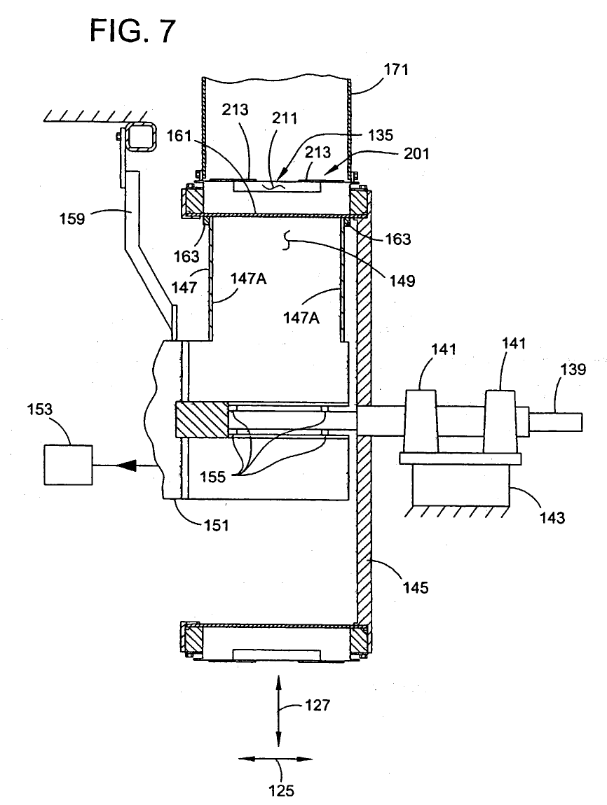

The apparatus (121) comprises an airforming device, generally indicated at (131) in FIGS. 5 and 6, having a movable, foraminous forming surface (135) extending about the circumference of a drum (137) (the reference numerals designating their subjects generally). The drum (137) is mounted on a shaft (139) (FIG. 7) connected by bearings (141) to a support (143). As shown in FIG. 7, the drum includes a circular wall (145) connected to the shaft (139) for conjoint rotation therewith. The shaft (139) is rotatably driven by a suitable motor or line shaft (not shown) in a counter-clockwise direction in the illustrated embodiment of FIGS. 5 and 6. The circular wall (145) cantilevers the forming surface (135) and the opposite side of the drum (137) is open. A vacuum duct (147) located radially inward of the forming surface (135) extends over an arc of the drum interior. The vacuum duct (147) has an arcuate, elongate entrance opening (149) under the foraminous forming surface (135), as will be described in more detail hereinafter, for fluid communication between the vacuum duct and the forming surface. The vacuum duct (147) is mounted on and in fluid communication with a vacuum conduit (151) connected to a vacuum source (153) (represented diagrammatically in FIG. 7). The vacuum source (153) may be, for example, an exhaust fan.

The vacuum duct (147) is connected to the vacuum supply conduit (151) along an outer peripheral surface of the conduit and extends circumferentially of the conduit. The vacuum duct (147) projects radially out from the vacuum conduit (151) toward the forming surface (135) and includes laterally spaced side walls (147A) and angularly spaced end walls (147B). The shaft (139) extends through the wall (145) and into the vacuum supply conduit (151) where it is received in a bearing (155) within the conduit. The bearing (155) is sealed with the vacuum supply conduit (151) so that air is not drawn in around the shaft (139) where it enters the conduit. The brace (157) and entire conduit (21) are supported by an overhead mount (159).

A drum rim (161) (FIG. 7) is mounted on the wall (145) of the drum (137) and has a multiplicity of holes over its surface area to provide a substantially free movement of fluid, such as air, through the thickness of the rim. The rim (161) is generally tubular in shape and extends around the axis of rotation of the shaft (139) near the periphery of the wall (145). The rim (161) is cantilevered away from the drum wall (145) and has a radially inward-facing surface positioned closely adjacent to the entrance opening (149) of the vacuum duct (147). To provide an air resistant seal between the rim (161) and the entrance opening (149) of the vacuum duct (147), rim seals (163) are mounted on the inward-facing surface of the rim (161) for sliding, sealing engagement with the walls (147A) of the vacuum duct. Seals (not shown) are also mounted on the end walls (147B) of the vacuum duct (147) for sliding, sealing engagement with the inward-facing surface of the rim (161). The seals may be formed of a suitable material such as felt to permit the sliding, sealing engagements.

Referring back to FIG. 6, the apparatus (121) further comprises a forming chamber (171) through which the forming surface (135) is movable conjointly with the drum (137) upon rotation thereof. More particularly, in the illustrated embodiment the forming surface (135) moves in a counter-clockwise direction within the forming chamber (171) generally from an entrance (173) through which the forming surface enters the forming chamber substantially free of fibrous material, and an exit (175) through which the forming surface exits the forming chamber with the pre-stabilized absorbent structure (101) formed thereon. Alternatively, the drum (137) may rotate in a clockwise direction relative to the forming chamber (171). The forming chamber (171) is supported by a suitable support frame (not shown) which may be anchored and/or joined to other suitable structural components as necessary or desirable.

The optional absorbent fiber material, such as in the form of a batt (177) (FIGS. 5 and 6) of absorbent fibers, may be delivered from a suitable supply source (not shown) into a fiberizer (179), which may be a conventional rotary hammer mill, a conventional rotatable picker roll or other suitable fiberizing device. The fiberizer (179) separates the batt (177) into discrete, loose absorbent fibers which are directed from the fiberizer into the interior of the forming chamber (171). In the illustrated embodiment, the fiberizer (179) is disposed above the forming chamber (171). However, it is to be understood that the fiberizer (179) may instead be located remote from the forming chamber (171) and that absorbent fibers may be delivered to the interior of the forming chamber in other ways by other suitable devices and remain within the scope of the present invention.

The absorbent composite (as well as particles or fibers of conventional superabsorbent material) may be introduced into the forming chamber (171) by employing conventional mechanisms such as pipes, channels, spreaders, nozzles and the like, as well as combinations thereof. In the illustrated embodiment, the absorbent composite is delivered into the forming chamber (171) via a delivery conduit (181) and nozzle system (not shown). A binder fiber material is delivered from a suitable binder fiber supply (183), such as in the form of bales (not shown), to a suitable opening device (185) to generally separate the binder fiber material into discrete, loose binder fibers. For example, the opening device (185) may be suitable for picking, carding, planing or the like, as well as combinations thereof.

Selected quantities of binder fiber are then directed to a metering device (187), and the metering device feeds controlled quantities of the binder fiber into a binder fiber delivery conduit (189). As an example, the binder fiber metering device (187) may be a model number CAM-1X12 device which is available from Fiber Controls, Inc., a business having offices located in Gastonia, N.C., U.S.A. A blower (191) or other suitable device may be employed to help the flow of binder fibers through the delivery conduit (189).

In the illustrated embodiment, the binder fiber conduit (189) delivers the binder fibers into the fiberizer (171) for generally homogenous mixing with the absorbent fibers such that a homogenous mixture of absorbent and binder fibers is subsequently delivered into the forming chamber (171). However, it is understood that the binder fibers may instead be delivered into the interior of the forming chamber (171) separate from the absorbent fibers, and at a location other than at the delivery point at which the absorbent fibers are directed by the fiberizer (179) into the forming chamber. This alternative is particularly suitable for those instances when it is desired to form an absorbent structure (101) that is substantially devoid of absorbent fibers.

Where the binder fibers are directed into the forming chamber (171) at a location which is closer to the entrance (173) of the forming chamber, the binder fibers will be more concentrated toward an inner or forming surface side (193) (FIG. 6) or major face of the absorbent structure (101) formed on the forming surface (135). Where the binder fibers are directed into the forming chamber (171) at a location which is closer to the exit (175) of the forming chamber, the binder fibers will be more concentrated toward an outer or free-surface side (195) (FIG. 6) or major face of the absorbent structure (101). As an alternative, the binder fibers may be combined with or otherwise incorporated into the source of the absorbent fibers instead of being separately delivered to the airforming device (131). For instance, the binder fibers may be blended with the absorbent fibers before the absorbent fibers are formed into a supply roll (e.g. the batt (177)).

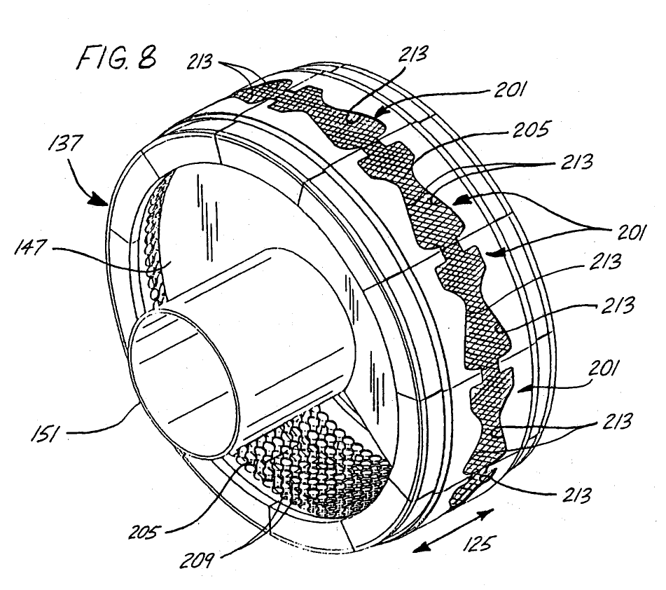

The foraminous forming surface (135) is defined in the illustrated embodiment by a series of mold elements, or form members (201) which are arranged end-to-end around the periphery of the forming drum (137) and independently attached to the drum. As may be seen in FIG. 8, the form members (201) each define a substantially identical pattern in which fibrous material is collected. The patterns correspond to a desired length, width and thickness of individual absorbent structures (101) which repeats over the circumference of the drum (137). However, partially repeating or non-repeating pattern shapes may be used. It is also understood that a continuous, un-patterned absorbent structure may be formed on the forming surface (135), such as where the forming surface is flat or where the formed absorbent structure is generally rectangular, and is subsequently processed (e.g., cut or otherwise formed) to a desired shape.

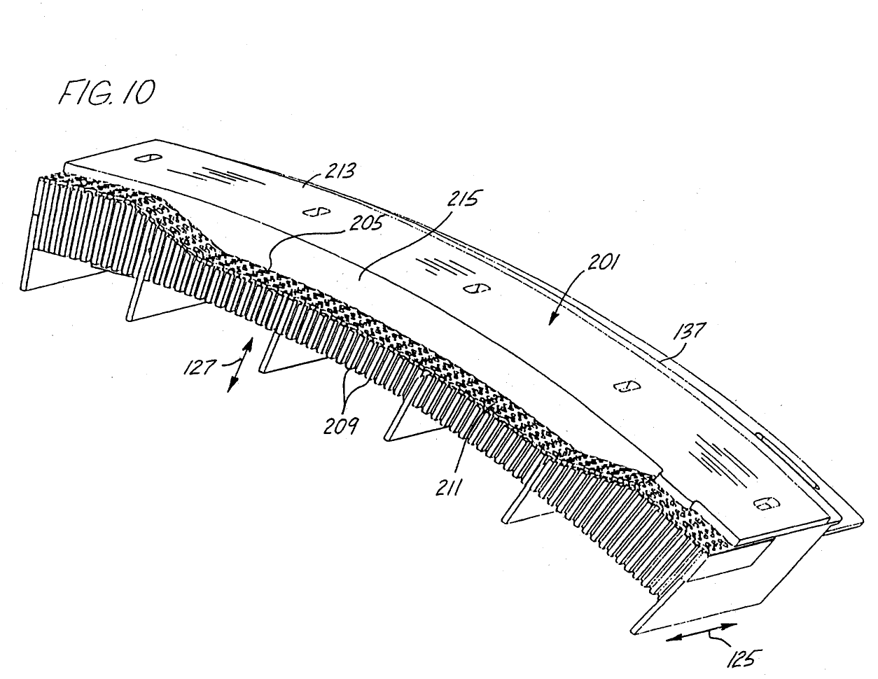

With general reference now to FIGS. 8-10, the form members (201) comprise a foraminous member (205) which is operatively located on and secured to the forming drum (135). The foraminous member (205) may include a screen, a wire mesh, a hard-wire cloth, a perforated member or the like, as well as combinations thereof. In the particular embodiment shown in FIG. 10, the foraminous member (205) is fluted to define open channels (209) which extend generally radially to allow a substantially free flow of air or other selected gas from the outer surface of the drum (137) toward the interior of the drum. The channels (209) can have any desired cross-sectional shape, such as circular, oval, hexagonal, pentagonal, other polygonal shape or the like, as well as combinations thereof.

With particular reference to FIG. 10, the radially outermost surface defined by the foraminous member (205) can be configured with a non-uniform depth-wise (e.g., z-direction (127)) surface contour to provide a desired non-uniform thickness of the pre-stabilized absorbent structure (101) formed on the forming surface (135). In desired arrangements, the z-direction (127) variation of the surface contour can have a selected pattern which may be regular or irregular in configuration. For example, the pattern of the surface contour can be configured to substantially provide a selected repeat-pattern along the circumferential dimension of the forming drum (137).

The surface contour of the foraminous member (205) shown in FIG. 10 thus defines longitudinally opposite end regions having a first average depth and a central region having a second average depth that is greater than the first average depth. Each end region with the first average depth can provide a lower-basis-weight region and/or thickness of the absorbent structure (101) formed on the forming surface (135), and the central region with the greater second average depth can provide a relatively higher-basis-weight and/or thickness region of the absorbent structure. Desirably, each region with the first average depth can be substantially contiguous with an adjacent region with the greater second depth. It is also understood that the foraminous member (205) may be configured to have a z-direction (127) surface contour across the width of the forming surface (135) for providing a non-uniform basis weight and/or thickness across the width of the absorbent structure (101) formed on-the forming surface.

In desired arrangements, the surface contour of the foraminous member (205) defines a generally trapezoidal shape. Alternatively, the contour may define a domed shape or may be flat. In the illustrated embodiment, the depth profile defined by the foraminous member (205) forms a pocket region (211) extending in the machine direction (123) along a portion of the length of the forming surface (135) and across a central portion of the width thereof for forming the absorbent structure shown in FIG. 4.

In a further aspect, one or more non-flow regions of the forming surface may be formed by employing a suitable blocking mechanism (not shown) which covers or otherwise occludes the flow of air through selected regions of the forming surface (135). As a result, the blocking mechanism can deflect or reduce the amount of fibers deposited on the areas of the forming surface (135) covered by the blocking mechanism. The blocking mechanism can optionally be configured to form other desired features of the absorbent structure (101), such as a series of key notches (not shown) on the formed absorbent structure. The key notches can, for example, provide a sensing point for locating and positioning a subsequent severing of a web of longitudinally connected absorbent structures (101) formed on the forming surface (135) into discrete absorbent structures.

Still referring to FIGS. 8-10, the form members (201) can also include one or more side-masking members (213), also sometimes referred to as contour rings, configured to provide a desired shape (e.g., width profile) to the absorbent structure (101). For example, in the illustrated embodiment the side-masking members (213) are provided by a pair of laterally opposed ring members which extend circumferentially around the forming drum (137) in laterally (cross-direction (125)) opposed relationship with each other. Each of the members (213) has a non-uniform inner side wall (215) along its respective length so that the laterally opposed inner side walls of the side-masking members (213) define the width profile of the absorbent structure (101) formed on the forming surface (135). More particularly, the inner side walls (215) of the side-masking members (213) have a generally serpentine contour as they extend in the machine direction (123). As a result, the side-masking members (213) provide alternating narrower and wider regions of the form members (201). Accordingly, the absorbent structure (101) delivered from the airforming device (131) can have a width profile which is non-uniform along at least a portion of the length of the structure.

In another feature, at least one of the side-masking members (213) can include one or more key tabs (not shown). The individual key tabs may, for example, be employed for marking or otherwise identifying each intended absorbent structure (101) length along the circumference of the forming drum (137). Such side-masking members (213) can be particularly advantageous when the airforming device (131) is employed to produce absorbent structures for use in disposable, shaped absorbent articles, such as diapers, children's training pants, feminine care products, adult incontinence products and the like.

It is understood that the inner side walls (215) of the side-masking members (213) can instead be generally straight (e.g., parallel to the machine direction (123)) to produce a substantially rectangular, ribbon shaped absorbent structure (101). It is also understood that the side edges (105) of the absorbent structure (101) can alternatively be provided by cutting and removal, cutting and folding, or the like, as well as combinations thereof.

While the forming surface (135) is illustrated herein as being part of the forming drum (137), it is to be understood that other techniques for providing the forming surface (135) may also be employed without departing from the scope of the present invention. For example, the forming surface (135) may be provided by an endless forming belt (not shown). A forming belt of this type is shown in U.S. Pat. No. 5,466,409 issued Nov. 14, 1995, to Partridge et al.

In operation to make a formed, non-woven pre-stabilized absorbent structure, e.g., prior to activation of the binder fibers to form inter-fiber bonds within the absorbent structure, the vacuum source (153) (FIG. 7) creates a vacuum in the vacuum duct (147) relative to the interior of the forming chamber (171). As the forming surface (135) enters and then moves through the forming chamber (171) toward the exit (175) thereof, the absorbent composite, binder fibers and, if present, the optional absorbent fibers within the forming chamber are operatively carried or transported by an entraining air stream and drawn inward by the vacuum toward the foraminous forming surface. It is understood that the absorbent composite and binder fibers (and, if present, the optional absorbent fibers) may be entrained in any suitable fluid medium within the forming chamber (171). Accordingly, any reference herein to air as being the entraining medium should be understood to be a general reference which encompasses any other operative entraining fluid. Air passes inward through the forming surface (135) and is subsequently passed out of the drum (137) through the vacuum supply conduit (151). The absorbent composite and binder fibers (and, if present, the optional absorbent fibers) are collected by the form members (201) to thereby form the pre-stabilized absorbent structure (101).

It is understood that the level or strength of the vacuum suction can be selectively regulated to control the density of the absorbent structure (101) formed on the forming surface (135). A relatively greater suction strength can be employed to produce a relatively higher density, or low porosity, in the absorbent structure (101), and a relatively lower suction strength can be employed to produce a relatively lower density, or high porosity, in the absorbent structure. The specific level of suction strength will depend upon the specific flow characteristics present in the forming chamber (171). It is readily apparent that a desired suction strength can be found by employing a short, iterative series of well known trial steps. The density of the absorbent structure (101) prior to activation of the binder fibers can be important for controlling the desired functional properties of the subsequently stabilized absorbent structure.

Subsequently, the drum (137) carrying the absorbent structure (101) passes out of the forming chamber (171) through the exit (175) to a scarfing system (generally indicated at 271 in FIGS. 5 and 6) where excess thickness of the absorbent structure can be trimmed and removed to a predetermined extent. The scarfing system (271) includes a scarfing chamber (273) and a scarfing roll (275) positioned within the scarfing chamber. The scarfing roll (275) abrades excess material from the absorbent structure (101), and the removed materials are transported away from the scarfing chamber (273) within a suitable discharge conduit as is well known in the art.

The rotatable scarfing roll (275) is operatively connected and joined to a suitable shaft member (not shown), and is driven by a suitable drive system (not shown). The drive system may include any conventional apparatus, such as a dedicated motor, or a coupling, gear or other transmission mechanism operatively connected to the motor or drive mechanism used to rotate the forming drum (137). The scarfing system (271) can provide a conventional trimming mechanism for removing or redistributing any excess thickness of the absorbent structure (101) that has been formed on the forming surface (135). The scarfing operation can yield an absorbent structure (101) having a selected contour on a major face-surface thereof (e.g., the free surface side (193) in the illustrated embodiment) that has been contacted by the scarfing roll (275). For example, the scarfing roll (275) may be configured to provide a substantially flat surface along the scarfed surface of the absorbent structure (101), or may optionally be configured to provide a non-flat surface. The scarfing roll (275) is disposed in spaced adjacent relationship with the forming surface (135), and the forming surface is translated past the scarfing roll upon rotation of the drum (137).

The scarfing roll (275) of the illustrated embodiment rotates in a clockwise direction which is counter to the direction of rotation of the drum (137). Alternatively, the scarfing roll (275) may be rotated in the same direction as the forming surface (135) on the forming drum (137). In either situation, the rotational speed of the scarfing roll (275) should be suitably selected to provide an effective scarfing action against the contacted surface of the formed absorbent structure (101). In like manner, any other suitable trimming mechanism may be employed in place of the scarfing system (271) to provide a cutting or abrading action to the absorbent structure (101) by a relative movement between the absorbent structure and the selected trimming mechanism.

After the scarfing operation, the portion of the forming surface (135) on which the absorbent structure (101) is formed can be moved to a release zone of the apparatus (121) disposed exterior of the forming chamber (171). In the release zone, the absorbent structure (101) is drawn away from the forming surface (135) onto a conveyor (which is indicated generally at 281 in FIGS. 5 and 6). The release can be assisted by the application of air pressure from the interior of the drum (137). The conveyor (281) receives the formed absorbent structure (101) from the forming drum (137) and conveys the absorbent structure to a collection area or to a location for further processing (not shown). Suitable conveyors can, for example, include conveyer belts, vacuum drums, transport rollers, electromagnetic suspension conveyors, fluid suspension conveyors or the like, as well as combinations thereof.

In the illustrated embodiment, the conveyor (281) includes an endless conveyor belt (283) disposed about rollers (285). A vacuum suction box (287) is located below the conveyor belt (283) to draw the absorbent structure (101) away from the forming surface (135). The belt (283) is perforate and the vacuum box (287) defines a plenum beneath the portion of the belt in close proximity to the forming surface so that the vacuum within the vacuum box acts on the absorbent structure (101) on the forming surface (135). Removal of the absorbent structure (101) from the forming surface (135) can alternatively be accomplished by the weight of the absorbent structure, by centrifugal force, by mechanical ejection, by positive air pressure or by some combination thereof or by another suitable method without departing from the scope of this invention. As an example, in the illustrated embodiment, the absorbent structures (101) exiting the forming chamber are interconnected end-to-end to form a web or series of absorbent structures, each of which has a selected shape that substantially matches the shape provided by the corresponding form members (201) used to form each individual absorbent structure.

Referring now to FIG. 5, after the pre-stabilized absorbent structures (101) are transferred from the forming surface (135) to the conveyor (281), each absorbent structure is subsequently transported to an activation system (304) wherein the binder fibers are activated to form inter-fiber bonds within the absorbent structure. In one embodiment, the binder activation system (304) includes an activation chamber (306) through which each absorbent structure (101) passes, and a generator (308) for radiating electromagnetic energy within the activation chamber as each absorbent structure passes therethrough. For example, a suitable microwave generator (308) can produce an operative amount of microwave energy, and can direct the energy through a suitable wave-guide (310) to the activation chamber (306).

In one embodiment, the electromagnetic energy may be RF energy having an RF frequency which is at least a minimum of about 0.3 megahertz (MHz). The frequency can alternatively be at least about 300 MHz, and can optionally be at least about 850 MHz. In other aspects, the frequency can be up to a maximum of about 300,000 MHz, or more. The frequency can alternatively be up to about 30,000 MHz, and can optionally be up to about 2,600 MHz. In a particular embodiment, the RF is desirably about 27 MHz. In another embodiment, the electromagnetic energy may be microwave energy in the range of about 915 MHz to about 2450 MHz.

In a particular arrangement, the electromagnetic energy can operatively heat the binder fibers to a temperature above the melting point of the binder fiber material. The melted binder fibers can then adhere or otherwise bond and operatively connect to the optional absorbent fibers, if present, to the absorbent composites and/or to other binder fibers within the absorbent structure. The binder fibers may also be activated substantially without heating up the entire mass of the absorbent structure (101). In a particular feature, the binder fibers can be rapidly activated while substantially avoiding any excessive burning of the absorbent structure (101).

The heating and melt activation of the binder fibers can be produced by any operative mechanism available in the absorbent structure (101). For example, the electromagnetic energy may heat water vapor present within the absorbent structure (101), and the heated vapor can operatively melt the binder fibers. In another mechanism, the electromagnetic energy can be absorbed by the binder fibers and the absorbed energy can operatively heat and melt the binder fibers. In another mechanism, the electromagnetic energy can be absorbed by the absorbent composite which in turn operatively heats and melts the binder fibers.

The total residence time of the absorbent structure (101) within the activation chamber (306) can provide a distinctively efficient activation period. In a particular aspect, the activation period can be at least a minimum of about 0.002 sec. The activation period can alternatively be at least about 0.005 sec, and can optionally be at least about 0.01 sec. In other aspects, the activation period can be up to a maximum of about 3 sec. The activation period can alternatively be up to about 2 sec, and can optionally be up to about 1.5 sec.

The activation chamber (304) can be a tuned chamber within which the electromagnetic energy can produce an operative standing wave. In a particular feature, the activation chamber (304) can be configured to be a resonant chamber. Examples of suitable arrangements for the resonant, activation chamber system are described in U.S. Pat. No. 5,536,921 issued Jul. 16, 1996, to Hedrick et al.; and in U.S. Pat. No. 5,916,203 issued Jun. 29, 1999, to Brandon et al. The entire disclosures of these documents are hereby incorporated herein by reference in a manner that is consistent herewith. Another suitable activation system for activating the binder fibers is disclosed in co-assigned U.S. patent application Ser. No. 10/037,385, filed Dec. 20, 2001, and entitled “Method and Apparatus for Making On-Line Stabilized Absorbent Materials.”

The absorbent structure (101) exiting the activation chamber (304) can also be selectively cooled or otherwise processed following heating of the binder fibers. The cooling of the absorbent structure (101) may be provided by a cooling system that includes: chilled air, a refrigerated atmosphere, radiant cooling, transvector cooling, ambient air cooling, or the like, as well as combinations thereof. As representatively shown in FIG. 5, the cooling system may include a chilled-air supply hood (321), a vacuum conveyor (323), a blower (325) and a chiller or other refrigeration unit (327). The refrigeration unit (327) can provide a suitable coolant to a heat exchanger (329), and the blower can circulate air through the heat exchanger for cooling. The cooled air can be directed into the supply hood (321) and onto the absorbent structure (101). The air can then be drawn out of the hood (321) for recirculation through the heat exchanger (329).

In a particular aspect, the absorbent structure (101) can be cooled to a setting temperature which is below the melting temperature of the binder fiber material. In another aspect, the absorbent structure (101) can be cooled to a temperature of not more than a maximum of 200° C. within a selected setting distance downstream of the activation chamber (304). In a further feature, the absorbent structure (101) can be cooled to a temperature of not more than a maximum of 150° C. within the selected setting distance. Accordingly, the setting distance can be measured after ending the exposure of the absorbent structure (101) to the high-frequency electromagnetic energy in the activation chamber (304). In a particular feature, the setting distance can be a minimum of about 0.5 m. The setting distance can alternatively be at least a minimum of about 0.75 m, and can optionally be at least about 1 m. In another feature, the setting distance can be a maximum of not more than about 30 m. The setting distance can alternatively be not more than about 20 m, and can optionally be not more than about 10 m.

In another aspect, an incremental portion of the heated absorbent structure (101) may be cooled to the desired setting temperature within a distinctive setting period, as determined from the time that the incremental portion of the activated structure exits the activation chamber (304). Accordingly, the setting period can be measured after ending the exposure of the absorbent structure to the high-frequency electromagnetic energy in the activation chamber (304). In a particular feature, the setting period can be a minimum of about 0.05 sec. The setting period can alternatively be at least a minimum of about 0.075 sec, and can optionally be at least about 0.1 sec. In another feature, the setting period can be a maximum of not more than about 3 sec. The setting period can alternatively be not more than about 2 sec., and can optionally be not more than about 1 sec.

The temperature of the absorbent structure (101) can be determined by employing an infrared scanner, such as a model No. LS601RC60 available from Land Infrared, a business having offices located in Bristol, Pa., U.S.A. With this device, the temperature can be determined by aiming the measurement probe at the centerline of the absorbent structure (101), and setting up the probe (in accordance with the instruction manual) at a separation distance of 12 inches, as measured perpendicular to the structure. Alternatively, a substantially equivalent device may be employed.

The stabilized absorbent structure (101) may also be compressed (e.g., by subjecting the structure to a debulking operation) to provide a desired thickness and density to the stabilized absorbent structure. In a desired aspect, the debulking is conducted after the absorbent structure has been cooled. As representatively shown, the debulking operation can be provided by a pair of counter-rotating nip rollers (331). The debulking operation can alternatively be provided by a converging conveyor system, indexed platens, elliptical rollers, or the like, as well as combinations thereof.

In a particular aspect, the thickness of the absorbent structure following debulking can be a minimum of about 0.5 mm. The debulked thickness can alternatively be at least about 1 mm, and can optionally be at least about 2 mm. In another aspect, the debulked thickness can be up to a maximum of about 25 mm. The debulked thickness can alternatively be up to about 15 mm, and can optionally be up to about 10 mm.

In another aspect, the debulked stabilized absorbent structure (101) can have a density which is at least a minimum of about 0.05 g/cm³. The debulked density can alternatively be at least about 0.08 g/cm³, and can optionally be at least about 0.1 g/cm³. In further aspects, the debulked density can be up to a maximum of about 0.5 g/cm³, or more. The debulked density can alternatively be up to about 0.45 g/cm³, and can optionally be up to about 0.4 g/cm³.

In optional configurations, the stabilized absorbent structure (101) may be cut or otherwise divided to provide a desired lateral shaping (e.g., width profile) of the structure, and/or to provide a laterally contoured structure. The cutting system may, for example, include a die cutter, a water cutter, rotary knives, reciprocating knives or the like, as well as combinations thereof. The shaping may be conducted prior to and/or after the absorbent structure (101) is subjected to the activation of the binder fiber with the selected activation system (304).

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. For example, features described in relation to one embodiment may be incorporated into any other embodiment of the invention.

### EXAMPLE

The following Example describes various embodiments of the invention. Other embodiments within the scope of the claims herein will be apparent to one skilled in the art from consideration of the specification or practice of the invention as disclosed herein. It is intended that the specification, together with the Example, be considered exemplary only, with the scope and spirit of the invention being indicated by the claims which follow the Example.

### EXAMPLE

Among other things, this Example serves to illustrate the relatively rapid and high heating rate of an absorbent composite as described herein when compared to a convention superabsorbent material that does not have an energy receptive additive on its surface.

Sample 1: DRYTECH 2035 superabsorbent, available from Dow Chemical Company, Midland, Mich., U.S.A., was sieved to 300-600 micron particle size using standard sieves. Also utilized in this example was India Ink, a source of carbon black, available in solution form from Speedball Art Products Company, 2226 Speedball Road., Statesville, N.C., U.S.A. The solids content of the India Ink was determined separately to be about 21 percent.

Specifically, an energy receptive additive, in the form of the India Ink solution, was mixed 1:1 with DRYTECH 2035 superabsorbent. The mixing occurred in a weighing dish using a spatula. The weighing dish and its contents were thereafter placed in an oven and dried at about 105° C. for approximately 1 hour. In this example, the absorbent composite was sieved with those particles have a size of 300-600 microns being utilized herein. The absorbent composite so formed contained approximately 83 percent (by weight) superabsorbent and approximately 17 percent (by weight) energy receptive additive. Particles of the absorbent composite were sprinkled on an airformed batt which is described below.

Sample 2: DRYTECH 2035 superabsorbent, available from Dow Chemical Company, Midland, Mich., U.S.A., was sieved to 300-600 micron particle size using standard sieves. Also utilized in this example was India Ink, a source of carbon black, available in solution form from Speedball Art Products Company, 2226 Speedball Road., Statesville, N.C., U.S.A. The solids content of the India Ink was determined separately to be about 21 percent.

Specifically, an energy receptive additive, in the form of the India Ink solution, was mixed 1:1 with DRYTECH 2035 superabsorbent. The mixing occurred in a weighing dish using a spatula. The weighing dish and its contents were thereafter placed in an oven and dried at about 105° C. for approximately 1 hour. In this example, the absorbent composite were sieved with those particles have a size greater than 600 microns being utilized herein. The absorbent composite so formed contained approximately 83 percent (by weight) superabsorbent and approximately 17 percent (by weight) energy receptive additive. Particles of the absorbent composite were sprinkled on an airformed batt which is described below.

Sample 3: DRYTECH 2035 superabsorbent, available from Dow Chemical Company, Midland, Mich., U.S.A., was sieved to 300-600 micron particle size using standard sieves. Also utilized in this example was a source of graphite in the form of a graphite stick, item No. 970A-BP, available from General Pencil Company, Inc., Jersey City, N.J.

Graphite, an energy receptive additive, was obtained by grinding the graphite stick in a mortar and pestle. The ground graphite was sieved such that particles of graphite having a size of 150-300 microns were utilized in this example. The ground graphite particles were mixed 4:1 with DRYTECH 2035 superabsorbent. The mixing occurred by placing the mixture in a sealed bottle and shaking vigorously by hand for a few minutes. A small amount of association agent (e.g., water) may also be utilized. Particles of the absorbent composite were sprinkled on an airformed batt which is described below.

Sample 4: DRYTECH 2035 superabsorbent, available from Dow Chemical Company, Midland, Mich., U.S.A., was sieved to 300-600 micron particle size using standard sieves. Also utilized in this example was a source of graphite in the form of a graphite stick, item No. 970A-BP, available from General Pencil Company, Inc., Jersey City, N.J.

Graphite, an energy receptive additive, was obtained by grinding the graphite stick in a mortar and pestle. The ground graphite was sieved such that particles of graphite having a size of less than 150 microns were utilized in this example. The ground graphite particles were mixed 4:1 with DRYTECH 2035 superabsorbent. The mixing occurred by placing the mixture in a sealed bottle and shaking vigorously by hand for a few minutes. A small amount of association agent (e.g., water) may also be utilized. Particles of the absorbent composite were sprinkled on an airformed batt which is described below.

Sample 5: This sample consisted of DRYTECH 2035 superabsorbent, available from Dow Chemical Company, Midland, Mich., U.S.A., which was sieved to 300-600 micron particle size using standard sieves. Particles of DRYTECH 2035 superabsorbent were sprinkled on an airformed batt which is described below.

Sample 6: This sample consisted of graphite. Initially in the form of a graphite stick, item No. 970A-BP, available from General Pencil Company, Inc., Jersey City, N.J., the graphite stick was ground in a mortar and pestle. The ground graphite was sieved such that particles of graphite having a particle size greater than 300 microns were used. Particles of graphite were sprinkled on an airformed batt which is described below

Sample 7: This sample consisted of India Ink, a source of carbon black, available in solution form from Speedball Art Products Company, 2226 Speedball Road., Statesville, N.C., U.S.A. The solids content of the India Ink was determined separately to be about 21 percent. Drops of the India Ink solution were placed on an airformed batt—which is described below—and partially dried at ambient conditions.

Airformed Batt: Airformed batts of T-255, a thermoplastic bicomponent binder fiber commercially available from KoSA, a business having offices located in Houston, Tex., U.S.A. were utilized in further examining the samples cited above. An airformed batt of T-255 thermoplastic bicomponent binder fiber was produced on a laboratory handshect former and manually compressed between flat plates to a density of about 0.08 g/cc. Three inch diameter circles were cut from the batt and the sample to be examined was sprinkled on the upper or top surface of the batt. The sample-containing batts were placed in a Sharp Model R-530EK microwave oven (available from Sharp Electronics Corp., a business having offices located in MahWah, N.J., U.S.A.) for 5 to 10 minutes on full power at 2450 MHz. The glass plate and turntable were removed. A temperature probe was slid into the middle of the sample, (below the sample sprinkled on top of the batt) from the cut edge of the sample. The temperature probe utilized herein was a FISO Technologies UMI-8 eight channel signal conditioner with a FOT-L low temperature sensor commercially available from FISO Technologies, Inc., a business having offices located in Sainte-Foy, Quebec, Canada. In between measurements, the microwave oven was allowed to cool. Temperature measurements were taken every 15 sec. Information concerning the sample-containing batts is provided in TABLE 1below:

TABLE 1

| Sample | Weight of T-255 | Weight of Sample |
|---|---|---|
| No. | (g) | (g) |
| 1 | 0.576 | 0.50 |
| 2 | 0.567 | 0.50 |
| 3 | 0.563 | 0.50 |
| 4 | 0.487 | 0.50 |
| 5 | 0.587 | 0.50 |
| 6 | 0.483 | 0.50 |
| 7 | 0.488 | 0.36 |

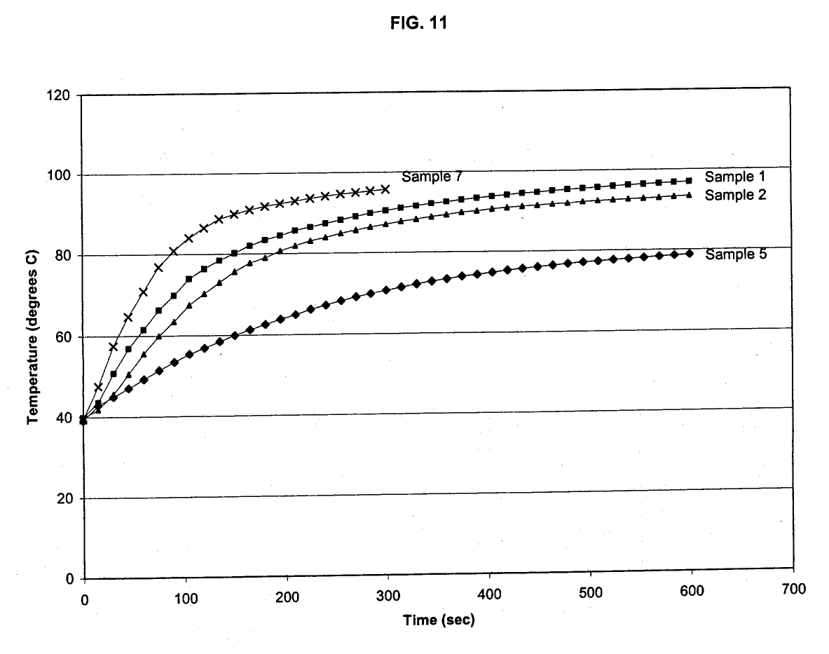

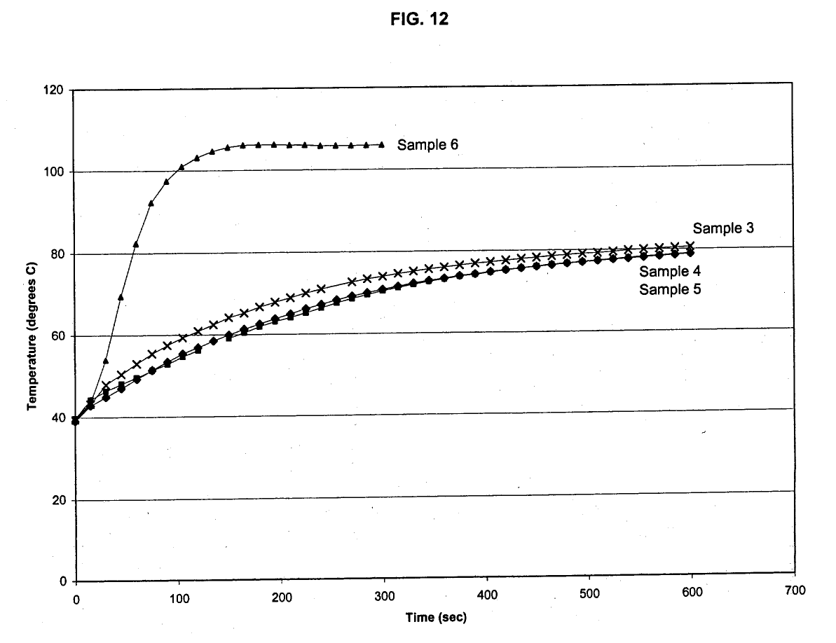

The results of the testing are graphically illustrated in FIGS. 11 and 12. As can be seen in FIG. 11, Sample 7 provides relatively rapid and high heating. Samples 1 and 2 also provide relatively more rapid heating rate than did Sample 5. As can be seen in FIG. 12, Sample 6 provides relatively rapid and high heating. The larger particle size of Sample 3, provided a relatively faster heating rate than either Sample 5 or Sample 4. It is believed that if desired the heating rate could be further enhanced by having a higher concentration of energy receptive additive on the surface of the superabsorbent.

Accordingly, all such modifications are intended to be included within the scope of this invention which is defined in the following claims and all equivalents thereto. Further, it is recognition that many embodiments may be conceived that do not achieve all of the advantages of some embodiments, particularly of the preferred embodiments, yet the absence of a particular advantage shall not be construed to necessarily mean that such an embodiment is outside the scope of the present invention.

As various changes could be made in the above constructions without departing from the scope of the invention, it is intended that all matter contained in the above description or shown in the accompanying drawings shall be interpreted as illustrative and not in a limiting sense.

What is claimed is:

1. An absorbent article comprising: a liner adapted for contiguous relationship with a wearer's body; an outer cover in generally opposed relationship with the liner; and an absorbent body disposed between the liner and the outer cover, the absorbent body comprising a non-woven absorbent structure having a unitary construction, the absorbent structure comprising binder fibers, activated to form inter-fiber bonds within the absorbent structure, and an absorbent composite, the absorbent composite comprising a superabsorbent material and an energy receptive additive, the energy receptive additive having a dielectric loss tangent of at least about 0.15.

2. The article of claim 1, wherein the binder fibers are activated by dielectrically heating the absorbent structure.

3. The article of claim 2, wherein the dielectric heating is microwave heating.

4. The article of claim 3, wherein the absorbent structure is airformed.

5. The article of claim 4, wherein the absorbent body further comprises absorbent fibers.

6. The article of claim 1, wherein the absorbent body further comprises absorbent fibers.

7. The article of claim 6, wherein the absorbent structure is airformed.

8. The article of claim 1, wherein the surface of the superabsorbent material is covered with the energy receptive additive.

9. The article of claim 8, wherein the energy receptive additive is in intimate association with the surface of the superabsorbent material.

10. The article of claim 9, wherein the energy receptive additive has a dielectric constant of at least about 4.

11. The article of claim 10, wherein the energy receptive additive is dielectrically heated.

12. The article of claim 11, wherein the dielectric heating is microwave heating.

13. The article of claim 12, wherein the dielectric constant is measured at a frequency of about 915 MHz.

14. The article of claim 13, wherein the absorbent structure is airformed.

15. The article of claim 14, wherein the absorbent body further comprises absorbent fibers.

16. An absorbent article comprising: a liner adapted for contiguous relationship with a wearer's body; an outer cover in generally opposed relationship with the liner; and a non-woven absorbent structure having a length, a width, a thickness and opposite major faces, the absorbent structure comprising binder fibers, activated to form inter-fiber bonds within the absorbent structure, and an absorbent composite, the absorbent composite comprising a superabsorbent material and an energy receptive additive, the energy receptive additive having a dielectric constant of at least about 4.

17. The article of claim 16, wherein the binder fibers are activated by dielectrically heating the absorbent structure.

18. The article of claim 17, wherein the dielectric heating is microwave heating.

19. The article of claim 16, wherein the absorbent structure is airformed.

20. The article of claim 19, wherein the absorbent body further comprises absorbent fibers.

21. The article of claim 16, wherein the absorbent body further comprises absorbent fibers.

22. The article of claim 21, wherein the absorbent structure is airformed.

23. The article of claim 16, wherein the surface of the superabsorbent material is covered with the energy receptive additive.

24. The article of claim 23, wherein the energy receptive additive is in intimate association with the surface of the superabsorbent material.

25. The article of claim 24, wherein the energy receptive additive has a dielectric loss tangent constant of at least about 0.15.

26. The article of claim 25, wherein the energy receptive is dielectrically heated.

27. The article of claim 26, wherein the dielectric heating is microwave heating.

28. The article of claim 27, wherein the dielectric constant is measured at a frequency of about 915 MHz.

29. The article of claim 28, wherein the absorbent structure is airformed.

30. The article of claim 29, wherein the absorbent body further comprises absorbent fibers.
